(19) United States
(12) Patent Application Publication
(10) Pub. No.: US 2013/0155124 A1
(43) Pub. Date: Jun. 20, 2013

(54) DISPLAY DEVICE AND METHOD OF DRIVING THE SAME

(71) Applicant: PANASONIC CORPORATION, Osaka (JP)

(72) Inventor: Hitoshi TSUGE, Osaka (JP)

(73) Assignee: PANASONIC CORPORATION, Osaka (JP)

(21) Appl. No.: 13/713,579

(22) Filed: Dec. 13, 2012

Related U.S. Application Data
(63) Continuation-in-part of application No. PCT/JP2011/007043, filed on Dec. 16, 2011.

(51) Int. Cl. G09G 5/10

(52) U.S. Cl. CPC G09G 5/10
USPC 345/690

(57) ABSTRACT

The method is for driving a display device including luminescence pixels arranged in rows and columns. The method includes: applying a black signal voltage to (a) a first target luminescence pixel in one row of each row pair and (b) a second target luminescence pixel in the other row at the same time, thereby starting the non-light-emission durations of the first and second target luminescence pixels simultaneously; (ii) applying a first data signal voltage to the first target luminescence pixel; (iii) applying a second data signal voltage to the second target luminescence pixel; and (iv) causing the first and second target luminescence pixels to emit light simultaneously based on these data signal voltages, thereby starting the light-emission durations of the first and the second target luminescence pixels simultaneously. The processing starts at different times for all row pairs.

### CROSS REFERENCE TO RELATED APPLICATION

This is a continuation application of International Application No. PCT/JP2011/007043 filed on Dec. 16, 2011, designating the United States of America. The entire disclosure of the above-identified application, including the specification, drawings and claims are incorporated herein by reference in its entirety.

### FIELD

One or more exemplary embodiments disclosed herein relate generally to display devices and methods of driving the display devices, and more particularly to a display device having current-driven luminescence elements and a method of driving the display device.

### BACKGROUND

Conventionally, various methods have been examined to display three-dimensional (3D) images. An example of such methods is disclosed, for example, in International Publication No. WO2010/082479 (Patent Literature 1) disclosing that image data for one eye and image data for the other eye, both of which correspond to a disparity for perceiving a 3D image, are alternately displayed on a display device, and shutters of an electric shutter glasses are also switched alternately, thereby generating the 3D image.

By the method disclosed in Patent Literature 1, image signals for one screen (one frame) of a 3D image is divided into the first frame having image data for one eye and the second frame having image data for the other eye. The image data of the first frame and the image data of the second frame are alternately displayed on a display unit according to a hold-type display method for holding luminance of a previous image until the display unit receives signals of a next image. A viewer can perceive the 3D image of one screen through electric shutter glasses having left and right shutters opening and closing in synchronization with the first frame and the second frame, respectively.

In addition, a black display duration is provided between a duration for displaying the image signals of the first frame and a duration for displaying the image signals of the second frame so that the viewer does not confuse the image of the first frame and the image of the second frame.

Here, FIG. 18 shows an example of scanning times of displaying an image by the display device disclosed in Patent Literature 1. FIG. 18 (a) shows times of scanning. FIG. 18 (b) shows times of shuttering a right-eye shutter of the shutter glasses. FIG. 18 (c) shows times of shuttering a left-eye shutter of the shutter glasses.

As seen in (b) and (c) in FIG. 18, the image display device disclosed in Patent Literature 1 starts shutter switching of the shutter glasses at time t₈₁. As shown in FIG. 18 (a), a duration from time t₈₁ to time t₈₃, scanning is performed to write display data into all of display lines (hereinafter, the scanning is referred to as “writing scanning”). At time t₈₃, all of the display lines start light emission at the same time. At time t₈₄, the light emission by all of the display lines stops, and the shutter switching and the writing scanning of display data start.

The above-described signal control allows the image display device disclosed in Patent Literature 1 to cause all of the display lines to start emitting light at the same time, at a time (time t₈₃ or time t₈₆ for example) of completing the writing scanning of a last display line (1080-th line).

### CITATION LIST

### Patent Literature

Patent Literature 1: International Publication No. WO2010/082479

### SUMMARY

### Technical Problem

Unfortunately, the image display device disclosed in Patent Literature 1 has the following problems.

The image display device disclosed in Patent Literature 1 employs a driving method of performing simultaneous lighting at a double speed of writing into a scan line driving circuit to display a 3D image. This driving method requires shift registers capable of high-speed processing corresponding to the double writing speed. However, such shift registers capable of high-speed processing are difficult to be implemented, and increase a cost. In addition, writing into pixels is also difficult.

In order to address the above-described problems, one non-limiting and exemplary embodiment provides a display device capable of displaying 3D images, keeping the same light-emission duration as the conventional one without increasing a writing speed, and a method of driving the display device.

### Solution to Problem

In one general aspect, the techniques disclosed here feature a method of driving a display device including a plurality of luminescence pixels arranged in rows and columns each of the luminescence pixels having (a) a light-emission duration in which the each of the luminescence pixels emits light and (b) a non-light-emission duration in which the each of the luminescence pixels does not emit light, and the method comprising: (i) applying a black signal voltage to (a) a first target luminescence pixel in luminescence pixels in one row of each of the pairs of the rows and (b) a second target luminescence pixel in luminescence pixels in an other row of the each of the pairs at the same time, thereby starting the non-light-emission duration of the first target luminescence pixel and the non-light-emission duration of the second target luminescence pixel at the same time, and (ii) applying a first data signal voltage corresponding to the first target luminescence pixel to the first target luminescence pixel; and (iii) applying a second data signal voltage corresponding to the second target luminescence pixel to the second target luminescence pixel, and (iv) causing the first target luminescence pixel and the second target luminescence pixel to emit light at the same time, based on the first data signal voltage and the second data signal voltage, respectively, thereby starting the light-emission duration of the first target luminescence pixel and the light-emission duration of the second target luminescence pixel at the same time, wherein a set of (i) the applying of the black signal voltage, (ii) the applying of the first data signal voltage, (iii) the applying of the second data signal voltage, and (iv) the causing to emit light starts at different times for the pairs of the rows.

These general and specific aspects may be implemented using a system, a method, an integrated circuit, a computer program, or a to computer-readable recording medium such as a CD-ROM, or any combination of systems, methods, integrated circuits, computer programs, or computer-readable recording media.

Additional benefits and advantages of the disclosed embodiments will be apparent from the Specification and Drawings. The benefits and/or advantages may be individually obtained by the various embodiments and features of the Specification and Drawings, which need not all be provided in order to obtain one or more of such benefits and/or advantages.

### Advantageous Effects

The display device and the method of driving the display device according to one or more exemplary embodiments or features disclosed herein are capable of displaying 3D images, keeping the same light-emission duration as the conventional one without increasing a writing speed.

### BRIEF DESCRIPTION OF DRAWINGS

These and other advantages and features will become apparent from the following description thereof taken in conjunction with the accompanying Drawings, by way of non-limiting examples of embodiments disclosed herein.

FIG. 1 is an example functional block diagram of a display device according to Embodiment 1.

FIG. 2 is a circuit diagram of a luminescence pixel included in the display device according to Embodiment 1.

FIG. 3 is a time chart for explaining a summary of processing performed by the pixel circuit shown in FIG. 2 in two-dimensional (2D) display driving.

FIG. 4 is a time chart for explaining an example of processing performed by the display device having pixel circuits 60 each shown in FIG. 2 in 2D display driving.

FIG. 5 is a diagram showing an example of a light emission pattern in the 2D display driving shown in FIG. 4.

FIG. 6 is a time chart for explaining an example of processing performed by the display device in 3D display driving, according to Embodiment 1.

FIG. 7 is a diagram showing an example of a light emission pattern in 3D display driving of the display device according to Embodiment 1.

FIG. 8 is a diagram showing an example of a gate driver included in a scan line driving circuit according to Embodiment 1.

FIG. 9 is a diagram showing an example of a light emission pattern in 3D display driving of a display device according to a variation of Embodiment 1.

FIG. 10 is a time chart showing an example of processing performed by the display device in 3D display driving, according to Embodiment 2.

FIG. 11 is a diagram showing an example of a light emission pattern in 3D display driving of the display device according to Embodiment 2.

FIG. 12 is a diagram showing an example of a gate driver included in a scan line driving circuit and an example of a 3D display driving waveform of the gate driver, according to Embodiment 2.

FIG. 13 is a diagram showing another example of the gate driver included in the scan line driving circuit and another example of the 2D display driving waveform of the gate driver, according to Embodiment 2.

FIG. 14 is a diagram showing an example of a light emission pattern in 3D display driving of a display device according to Embodiment 3.

FIG. 15 is a diagram for explaining a pulse transmission direction of a gate driver included in a scan line driving circuit according to Embodiment 3.

FIG. 16 is a diagram showing another example of the light emission pattern in the 3D display driving of the display device according to Embodiment 3.

FIG. 17 is an external view of a thin flat TV set including the display device according to any one of the exemplary embodiments.

FIG. 18 is a diagram showing an example of scan times of displaying images by the display device disclosed in Patent Literature 1.

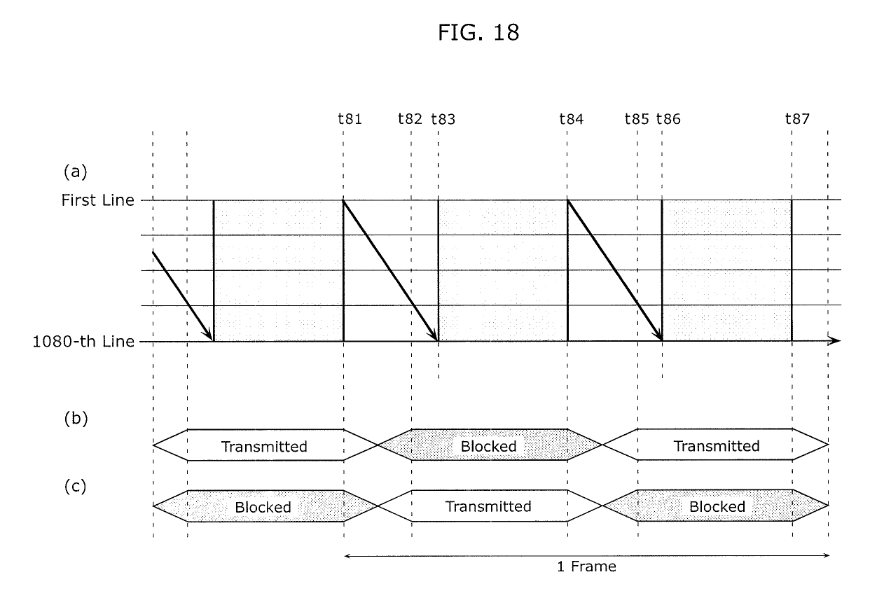

### DESCRIPTION OF EMBODIMENT(S)

According to an exemplary embodiment disclosed herein, a method of driving a display device including a plurality of luminescence pixels arranged in rows and columns, each of the luminescence pixels having (a) a light-emission duration in which the each of the luminescence pixels emits light and (b) a non-light-emission duration in which the each of the luminescence pixels does not emit light, and the method including: (i) applying a black signal voltage to (a) a first target luminescence pixel in luminescence pixels in one row of each of the pairs of the rows and (b) a second target luminescence pixel in luminescence pixels in an other row of the each of the pairs at the same time, thereby starting the non-light-emission duration of the first target luminescence pixel and the non-light-emission duration of the second target luminescence pixel at the same time, and (ii) applying a first data signal voltage corresponding to the first target luminescence pixel to the first target luminescence pixel; and (iii) applying a second data signal voltage corresponding to the second target luminescence pixel to the second target luminescence pixel, and (iv) causing the first target luminescence pixel and the second target luminescence pixel to emit light at the same time, based on the first data signal voltage and the second data signal voltage, respectively, thereby starting the light-emission duration of the first target luminescence pixel and the light-emission duration of the second target luminescence pixel at the same time, wherein a set of (i) the applying of the black signal voltage, (ii) the applying of the first data signal voltage, (iii) the applying of the second data signal voltage, and (iv) the causing to emit light, the set starting at different times for the pairs of the rows.

For example, each of the luminescence pixels may have a one-frame duration that consists of the light-emission duration and the non-light-emission duration, and the method may include: (i) performing an operation of a light-emission duration in the one-frame duration for every one of the luminescence pixels arranged in rows and columns to display one of a right-eye image and a left-eye image of a three-dimensional image, and (ii) performing an operation of the light-emission duration in a next one-frame duration following the one-frame duration for every one of the luminescence pixels arranged in rows and columns to display an other one of the right-eye image and the left-eye image, thereby allowing a user to perceive the three-dimensional image through glasses that enable the user to sequentially see the right-eye image and the left-eye image.

For example, it is possible that the luminescence pixels in the one row belong to one of an odd row group and an even row group of the rows, and that the luminescence pixels in the other row belong to an other of the odd row group and the even row group of the rows.

For example, it is possible that the luminescence pixels in the one row belong to one of an upper region and a lower region of the rows, and that the luminescence pixels in the other row belong to an other of the upper region and the lower region of the rows.

According to another exemplary embodiment disclosed herein, a display device including: a plurality of luminescence pixels arranged in rows and columns, each of the luminescence pixels having (a) a light-emission duration in which the each of the luminescence pixels emits light and (b) a non-light-emission duration in which the each of the luminescence pixels does not emit light; a control unit configured to: (i) apply a black signal voltage to (a) a first target luminescence pixel in luminescence pixels in one row of each of the pairs of the rows and (b) a second target luminescence pixel in luminescence pixels in an other row of the each of the pairs at the same time, thereby starting the non-light-emission duration of the first target luminescence pixel and the non-light-emission duration of the second target luminescence pixel at the same time; (ii) apply a first data signal voltage corresponding to the first target luminescence pixel to the first target luminescence pixel; (iii) apply a second data signal voltage corresponding to the second target luminescence pixel to the second target luminescence pixel; and (iv) cause the first target luminescence pixel and the second target luminescence pixel to emit light at the same time, based on the first data signal voltage and the second data signal voltage, respectively, thereby starting the light-emission duration of the first target luminescence pixel and the light-emission duration of the second target luminescence pixel at the same time, wherein the control unit is configured to perform a set of (i) the applying of the black signal voltage, (ii) the applying of the first data signal voltage, (iii) the applying of the second data signal voltage, and (iv) the causing to emit light, the set starting at different times for the pairs of the rows.

For example, it is possible that each of the luminescence pixels includes at least: a luminescence element; a storage capacitor that stores a voltage; a first switch that switches a state between a first power line that supplies the black signal voltage and a first electrode of the storage capacitor to be conductive or not to be conductive; a second switch that switches a state between a signal line that supplies the data signal voltage and a second electrode of the storage capacitor to be conductive or not to be conductive; a third switch that switches a state between the second electrode of the storage capacitor and a source electrode of a driving transistor to be conductive or not to be conductive; and the driving transistor that causes a current corresponding to the data signal voltage to flow in the luminescence element, thereby causing the luminescence element to emit light, when a gate electrode of the driving transistor is conductive with the first electrode of the storage capacitor and the data signal voltage stored in the second electrode of the storage capacitor is conductive with the source electrode of the driving transistor, wherein the switching by the first switch is synchronization with the switching by the second switch.

These general and specific aspects may be implemented using a system, a method, an integrated circuit, a computer program, or a computer-readable recording medium such as a CD-ROM, or any combination of systems, methods, integrated circuits, computer programs, or computer-readable recording media.

Hereinafter, certain exemplary embodiments are described in greater detail with reference to the accompanying Drawings.

Each of the exemplary embodiments described below shows a general or specific example. The numerical values, shapes, materials, structural elements, the arrangement and connection of the structural elements, steps, the processing order of the steps etc. shown in the following exemplary embodiments are mere examples, and therefore do not limit the scope of the appended Claims and their equivalents. Therefore, among the structural elements in the following exemplary embodiments, structural elements not recited in any one of the independent claims are described as arbitrary structural elements.

### Embodiment 1

The following describes the display device and the method of driving the display device according to the exemplary embodiments. It should be noted that the present invention is based not on the exemplary embodiments but on the general aspect. Therefore, structural elements which are described in the following embodiments but not in the claims are not essential to solve the technical problems addressed by the present invention, but are included in a more desirable example of the present invention. Each of the figures in the drawings is merely schematic diagrams not illustrating the present invention strictly.

Each of the exemplary embodiments is an example of applying the display device to a 3D image display device used with shutter glasses. The shutter glasses block a view of a left eye and a view of a right eye alternately in synchronization with image display switching. The following describes examples of the display device having organic electroluminescence (EL) elements as elements that emit light.

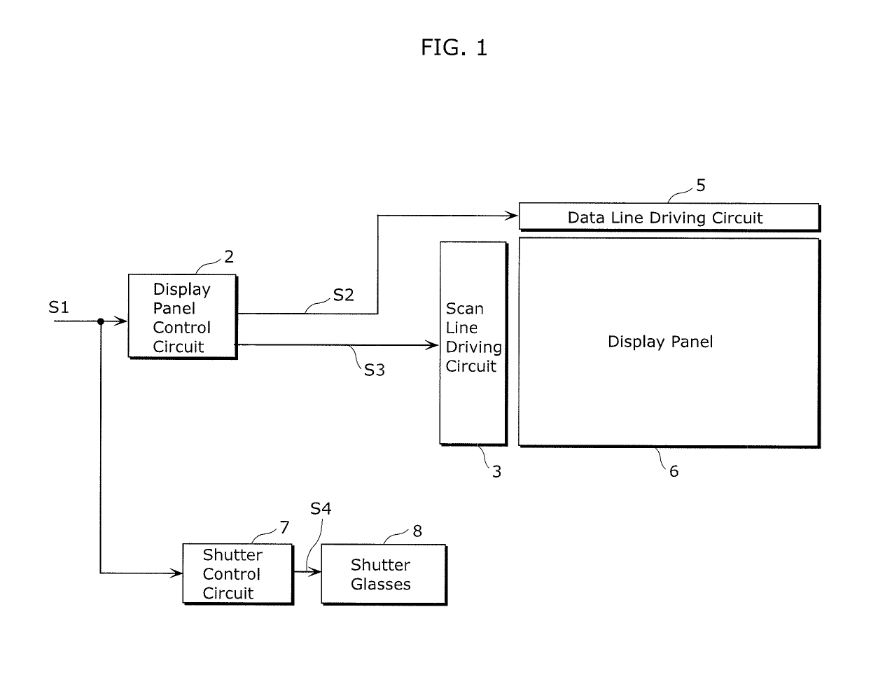

FIG. 1 is an example functional block diagram of a display device according to Embodiment 1.

The display device 1 shown in FIG. 1 includes a display panel control circuit 2, a scan line driving circuit 3, a data line driving circuit 5, a display panel 6, a shutter control circuit 7, and shutter glasses 8.

An example of the display panel 6 is an organic EL panel. The display panel 6 includes: N (where N=1080, for example) scan lines and N merge lines all of which are arranged in parallel to one another; and M source signal lines perpendicular to the scan lines and the merge lines (they are not shown in the figure). The display panel 6 also includes pixel circuits (not shown) each of which has a thin-film transistor and an EL element and is arranged at a corresponding node between a source signal line and a scan line. Hereinafter, a set of pixel circuits arranged along the same scan line is referred to as a “display line” for the sake of convenience in the description. In other words, in the display panel 6, N display lines each having M EL elements are arranged.

The display panel control circuit 2 corresponds to the control unit according to the general aspect of the present invention. Note that a plurality of luminescence pixels (pixel circuits) are arranged in a matrix. Each of the luminescence pixels (pixel circuits) has a light-emission duration in which the luminescence pixel emits light and a non-light-emission duration in which the luminescence pixel does not emit light. At different times for each pair of the rows in the matrix, the display panel control circuit 2 performs the following. The display panel control circuit 2 applies a black signal voltage to (a) a target luminescence pixel (pixel circuit) in one row of a target pair and (b) the other target luminescence pixel (pixel circuit) in the other row of the target pair at the same time. As a result, the display panel control circuit 2 starts respective non-light-emission durations of the target luminescence pixels in the two rows at the same time. Furthermore, for the target pair, (at the time of starting the respective non-light-emission durations), the display panel control circuit 2 writes (applies) a corresponding data signal voltage to the target luminescence pixel (pixel circuit) in one row in the pair. After the application of the black signal voltage, the display panel control circuit 2 writes (applies) a different corresponding data signal voltage to the other target luminescence pixel in the other row. After having written the data signal voltage, the display panel control circuit 2 ends the respective non-light-emission durations. Then, for the target pair, when the respective non-light-emission durations are completed, the display panel control circuit 2 causes the target luminescence pixel (pixel circuit) in one row and the other target luminescence pixel (pixel circuit) in the other row to emit light at the same time according to the respective written data signal voltages. As a result, for the target pair, the display panel control circuit 2 starts a light-emission duration of the target luminescence pixel in one row and a light-emission duration of the other target luminescence pixel in the other row at the same time. The above processing (in other words, the processing including: application of the black signal voltage to all target luminescence pixels in a target pair; writing of a data signal voltage to one of the target luminescence pixels; writing of another data signal voltage to the other target luminescence pixel; and causing the all target luminescence pixels to emit light) starts at different times for the pairs.

More specifically, the display panel control circuit 2 generates, based on a display data signal S1, a control signal S2 for controlling the data line driving circuit 5, and issues the generated control signal S2 to the data line driving circuit 5. Furthermore, the display panel control circuit 2 generates, based on the input synchronization signal, a control signal S3 for controlling the scan line driving circuit 3. Then, the display panel control circuit 2 issues the generated control signal 3 to the scan line driving circuit 3.

Here, the display data signal S1 is a signal indicating display data that includes a video signal, a vertical synchronization signal, and a horizontal synchronization signal. The video signal is a signal designating (a) pixel values that are graduation information of a left-eye image and (b) pixel values that are graduation information of a right-eye image of each frame. The vertical synchronization signal is a signal for synchronizing times of performing processes on an image in a vertical direction. Here, according to the vertical synchronization signal, the process for the left-eye image and the process for the right-eye image are to be performed for each frame. The horizontal synchronization signal is a signal for synchronizing times of performing processes on the image in a horizontal direction. Here, according to the horizontal synchronization signal, the processes are performed for each display line.

The control signal S2 includes the video signal and the horizontal synchronization signal. The control signal S3 includes the vertical synchronization signal and the horizontal synchronization signal.

The data line driving circuit 5 drives the source signal lines of the display panel 6, based on the control signal S2 generated by the display panel control circuit 2. More specifically, the data line driving circuit 5 issues the source signal to each of the pixel circuits, based on the video signal and the horizontal synchronization signal.

The scan line driving circuit 3 drives the scan lines of the display panel 6, based on the control signal S3 generated by the display panel control circuit 2. More specifically, the scan line driving circuit 3 issues a scan signal and a merge signal to each of at least the display lines, based on the vertical synchronization signal and the horizontal synchronization signal.

The shutter control circuit 7 generates, based on the display data signal S1, a shutter control signal S4 for instructing shutter switching to the shutter glasses 8. Then, the shutter control circuit 7 transmits the generated shutter control signal S4 to the shutter glasses 8, for example, by infrared communication. In other words, the shutter control circuit 7 is a block timing control unit that controls times of switching a blocking state between the glasses capable of alternately blocking the left-eye view and the right-eye view.

An example of the shutter glasses 8 is glasses in which liquid crystal shutters are arranged on respective lens parts for the eyes. More specifically, the shutter glasses 8 switch a blocking state between the left lens and the right lens according to the shutter control signal S4. As a result, the images displayed on the display panel 6 are alternately perceived by the left eye and the right eye.

Thus, the display device 1 has the structure as described above.

It should be noted that the display device 1 may include a Central Processing Unit (CPU), a storage medium such as a Read Only Memory (ROM) holding a control program, a working memory such as a Random Access Memory (RAM), and a communication circuit (they are not shown in the figure). For example, the display data signal S1 may be generated, for instance, by executing the control program by the CPU.

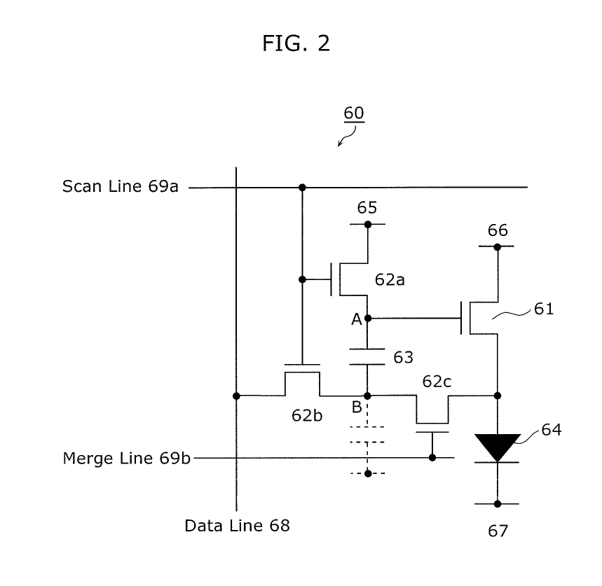

FIG. 2 is a circuit diagram of a luminescence pixel included in the display device according to Embodiment 1.

The pixel circuit 60 shown in FIG. 2 is one of pixels included in the display panel 6. The pixel circuit 60 has a function of emitting light by receiving a data signal voltage (data signal) via the data line 68.

The pixel circuit 60 corresponds to the luminescence pixel according to the general aspect of the present invention. The pixel circuit 60 are arranged in a matrix. The pixel circuit 60 includes a driving transistor 60, a switch 62a, a switch 62b, a switch 62c, a storage capacitor 63, and an EL element 64. The pixel circuit 60 is connected to a data line 68, an EL anode power line 66, an EL cathode power line 67, a scan line 69a, a merge line 69b, and a reference voltage power line 65. The data line 68 is used to supply the data signal voltage. The EL anode power line 66 is a high-voltage power line for determining a potential of a drain electrode of the driving transistor 61. The EL cathode power line 67 is a low-voltage power line connected to a second electrode of the EL element 64. The reference voltage power line 65 is used to supply a reference voltage (black signal voltage) for determining a voltage value of a first electrode of the storage capacitor 63.

The EL element 64 corresponds to the luminescence element according to the general aspect of the present invention. A plurality of the EL elements 64 are arranged in a matrix. Each of the EL elements 64 has a light-emission duration in which the EL element 64 emits light and a non-light-emission duration in which the EL element 64 does not emit light. The EL element 64 emits light by receiving a driving current of the driving transistor 61. An example of the EL element 64 is an organic EL element. The EL element 64 has: a cathode (second electrode) connected to the EL cathode power line 67; and an anode (first electrode) connected to the source (source electrode) of the driving transistor 61. Here, a voltage supplied to the EL cathode power line 67 is Vs, for example, 0 (v).

The driving transistor 61 is a driving element for driving a voltage to control supply of current to the EL element 64. The driving transistor 61 lets a current flow in the EL element 64 to cause the EL element 64 to emit light. More specifically, the driving transistor 61 has a gate electrode conductive with a first electrode of the storage capacitor 63. When the data signal voltage held at a second electrode of the storage capacitor 63 becomes conductive with the source electrode, the driving transistor 61 lets a current corresponding to the data signal voltage into the EL element 64 to cause the EL element 64 to emit light. The driving transistor 61 has: a gate (gate electrode) connected to the data line 68 via the switch 62c and the switch 62b; a source (source electrode) connected to the anode (first electrode) of the EL element 64; and a drain (drain electrode) connected to the EL anode power line 66. Here, a voltage supplied to the EL anode power line 66 is Vdd, for example, 20 V. With the above structure, the driving transistor 61 converts the data signal voltage (data signal) supplied to the gate electrode into a signal current corresponding to the data signal voltage (data signal), and provides the resulting signal current to the EL element 64.

The storage capacitor 63 keeps the voltage for determining an amount of the current to be caused by the driving transistor 61 to flow. More specifically, the second electrode (electrode close to a node B) of the storage capacitor 63 is connected between the source (close to the EL cathode power line 67) of the driving transistor 61 and the anode (first electrode) of the EL element 64 via the switch 62c. The first electrode (electrode close to a node A) of the storage capacitor 63 is connected to the gate of the driving transistor 61. Furthermore, the first electrode of the storage capacitor 63 is connected to the reference voltage power 65 via the switch 62a.

The storage capacitor 63 keeps the applied reference voltage (black signal voltage) even after, for example, turning the switch 62a OFF. Therefore, the storage capacitor 63 keeps supplying the reference voltage (black signal voltage) to the gate of the driving transistor 61. When the switch 62b is turned ON and the data signal voltage is applied to the second electrode to turn the switch 62b OFF, the storage capacitor 63 holds the data signal voltage at the second electrode. Then, when the switch 62c is turned ON, the storage capacitor 63 applies the data signal voltage stored at the second electrode to the source of the driving transistor 61. As a result, the driving transistor 61 is caused to supply a driving current to the EL element 64. Here, the storage capacitor 63 stores the data signal voltage as electric charges generated by integrating capacitance to the data signal voltage.

The switch 62a corresponds to the first switch according to the general aspect of the present invention. The switch 62a switches a state between the reference voltage power line 65 (first power line) supplying the reference voltage (black signal voltage) and the first electrode of the storage capacitor 63, to be conductive or non-conductive. More specifically, the switch 62a is a switching transistor having the following structure. A terminal at one of a drain and a source of the switch 62a is connected to the reference voltage power 65. A terminal at the other one of the drain and the source is connected to the first electrode of the storage capacitor 63. A gate of the switch 62a is connected to the scan line 69a. In other words, the switch 62a has a function of providing the black signal voltage (reference voltage) to the first electrode (gate of the driving transistor 61) of the storage capacitor 63.

The switch 62b corresponds to the second switch according to the general aspect of the present invention. The switch 62b switches a state between a signal line for supplying the data signal voltage and the second electrode of the storage capacitor 63, to be conductive or non-conductive. More specifically, the switch 62b is a switching transistor having the following structure. A terminal at one of a drain and a source of the switch 62b is connected to the data line 68. A terminal at the other one of the drain and the source is connected to the second electrode of the storage capacitor 63. A gate of the switch 62b is connected to the scan line 69a. In other words, the switch 62b has a function of writing the data signal voltage (data signal) corresponding to the video signal voltage (video signal) supplied via the data line 68 to the second electrode of the storage capacitor 63. As described above, both the gate of the switch 62a and the gate of the switch 62b are connected to the scan line 69a.

The switch 62c corresponds to the third switch according to the general aspect of the present invention. The switch 62c switches a state between the second electrode of the storage capacitor 63 and the source of the driving transistor 61, to be conductive or non-conductive. More specifically, the switch 62c is a switching transistor having the following structure. A terminal at one of a drain and a source of the switch 62c is connected to the source of the driving transistor 61. A terminal at the other one of the drain and the source is connected to the second electrode of the storage capacitor 63. A gate of the switch 62c is connected to the merge line 69b. In other words, the switch 62c has a function of separating the second electrode of the storage capacitor 63 from the driving transistor 61 in a writing duration in which the data signal voltage is written into the second electrode of the storage capacitor 63.

Thus, the pixel circuit 60 has the structure as described above.

Hereinafter, the switches 62a to 62c included in the pixel circuit 60 will be described as n-type TFTs, but they are not limited to the n-type TFTs. The switches 62a to 62c may be p-type TFTs. The p-type TFTs can be implemented only by inverting the polarity of the gate signal inputted in the scan line 69a.

Voltages at the reference voltage power line 65, the EL anode power line 66, and the EL cathode power line 67 are set as follows.

(voltage at EL anode power line 66)−(voltage at EL cathode power line 67)>(voltage required for maximum gradation display of EL element 64)+(drain-to-source voltage required for operating driving transistor 61 in saturated region).

(voltage at reference voltage power line 65)−(voltage at EL cathode power line 67)<(threshold voltage at driving transistor 61)+(threshold voltage at EL element 64).

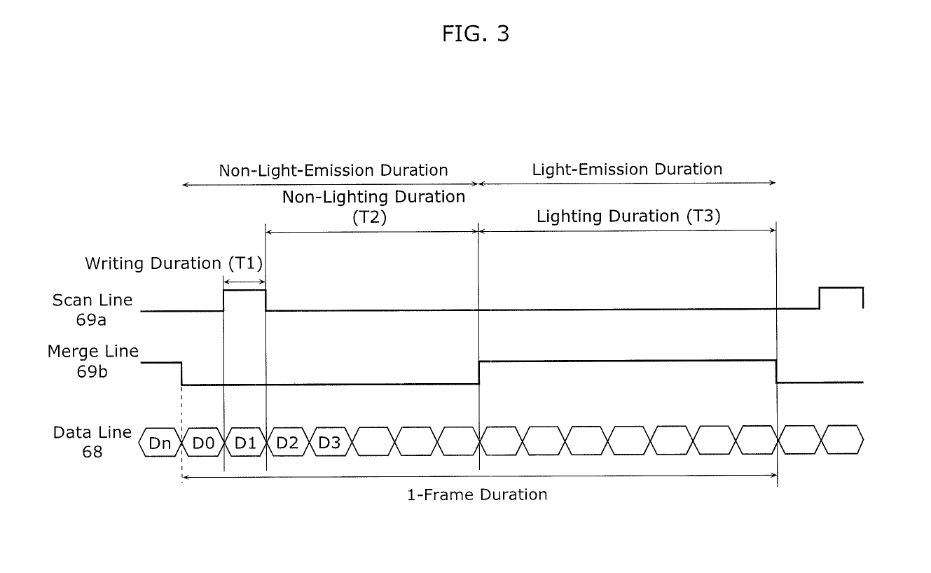

Next, the summary of processing performed by the pixel circuit shown in FIG. 2 (in 2D display processing) is described. FIG. 3 is a time chart for explaining a summary of the processing performed by the pixel circuit shown in FIG. 2 in 2D display driving.

For each of the pixel circuits 60, the display panel control circuit 2 performs, within one frame duration (hereinafter, referred to as a “1-frame duration”), (a) processing for writing (applying) a data signal voltage (data signal) corresponding to a video signal into the storage capacitor 63, and (b) processing for causing the EL element 64 to emit light according to the voltage written in the storage capacitor 63. Here, a duration in which a data signal voltage corresponding to a video signal is written into the storage capacitor 63 is referred to as a writing duration T1. A duration in which the EL element 64 is caused to emit light according to the voltage written in the storage capacitor 63 is referred to as a lighting duration T3 (light-emission duration). A duration from the end of the writing duration (T1) to the start of the lighting duration (T3) is referred to as a non-lighting duration T2.

(Writing Duration T1)

In a writing duration T1, the data line driving circuit 5 writes a data signal voltage (D1, for example), such as a gradation voltage corresponding to display gradation, into a target pixel circuit 60 via the data line 68. Here, the scan line driving circuit 3 sets High a scan signal applied to a corresponding scan line 69a, thereby causing a switch 62a and a switch 62b in the target pixel circuit 60 to be conductive. As a result, at both ends of a storage capacitor 63 in the target pixel circuit 60, a node A receives a reference voltage via the reference voltage power line 65, while a node B receives the data signal voltage D1 via the data line 68.

In the same writing duration, the scan line driving circuit 3 sets Low, a merge, signal applied to a corresponding merge line 69b, thereby causing a switch 62c in the target pixel circuit 60 to be non-conductive. As a result, the data signal voltage D1 is more likely to be written into the node B via the data line 68, and the data signal voltage D1 is prevented from causing a current to flow in the EL element 64 via the data line 68.

(Non-Lighting Duration T2)

The scan line driving circuit 3 adds a non-lighting duration T2 as needed. For example, when a non-lighting duration T2 serving as a black addition duration is not necessary, the scan line driving circuit 3 does not need to add the non-lighting duration T2.

In a non-lighting duration T2, the scan line driving circuit 3 sets Low a scan signal applied to the corresponding scan line 69a. The scan line driving circuit 3 thereby causes the switch 62a and the switch 62b in the target pixel circuit 60 to be non-conductive. In the non-lighting duration T2, the scan line driving circuit 3 keeps Low a merge signal applied to the corresponding merge line 69b. As a result, the scan line driving circuit 3 keeps the switch 62c in the target pixel circuit 60 being non-conductive in the non-lighting duration T2.

In other words, after the writing duration T1, the node A receives the reference voltage (black signal voltage). Then, the scan line driving circuit 3 causes the switch 62a and the switch 62b to be non-conductive, and the node A keeps the reference voltage (black signal voltage).

As a result, a source-to-gate voltage at the driving transistor 61 is lower, by a voltage applied to the EL element 64, than a potential difference between the reference voltage (black signal voltage) of the reference voltage power line 65 and the voltage at the EL cathode power source 17. Therefore, the applied source-to-gate voltage at the driving transistor 61 is only lower than or equal to at least the threshold voltage at the driving transistor 61.

As a result, the drain current does not flow in the driving transistor 61, and no current therefore flows in the EL element 64. In this manner, the display panel control circuit 2 causes the target pixel circuit 60 to perform the process of the non-lighting duration T2.

Here, in order to perform the process of the non-lighting duration T2, it is only necessary that the switch 62a sets the voltage at the node A to be equal to the reference voltage at the reference voltage power line 65. In other words, the node B may have any voltage.

(Lighting Duration T3)

In a lighting duration T3, the scan line driving circuit 3 keeps Low a scan signal applied to the corresponding scan line 69b. In other words, the scan line driving circuit 3 keeps the switch 62a and the switch 62b being non-conductive. In the lighting duration 3, the scan line driving circuit 3 sets High a merge signal applied to the corresponding merge line 69b. Thereby, the scan line driving circuit 3 causes the switch 62c to be conductive.

In other words, in the lighting duration T3, the scan line driving circuit 3 sets High a merge signal applied to the corresponding merge line 69b to cause the switch 62c to be conductive. Thereby, the data signal voltage (D1) at the node B is applied to the source of the driving transistor 61, and the source-to-gate voltage at the driving transistor 61 becomes equal to the voltage at the storage capacitor 63. In other words, the drain current flows in the driving transistor 61 according to the voltage at the storage capacitor 63. The drain current enters the EL element 64 to cause the EL element 64 to emit light. Here, the source potential at the driving transistor 61 and the voltages at the nodes A and B are increased according to the current-to-voltage characteristics of the EL element 64.

As described above, the driving transistor 61 supplies the drain current to the EL element 64 according to the data signal voltage (D1) written in the writing duration T1, thereby causing the EL element 64 to emit light. In other words, the voltage necessary in the EL element 64 is ensured by changes of the node A and the node B by bootstrap.

As described above, the display panel control circuit 2 performs the process of the writing duration T1, the process of the non-lighting duration T2, and the process of the lighting duration T3 on the target pixel circuit 60, thereby causing the target pixel circuit 60 to display gradation.

It should be noted that the above description has been given for the process performed on a representative pixel in a target line for the sake of simplicity in the description. In practical, the process sequentially starts at different times for all pixels in each line. Next, the description is given for the process performed on the pixel circuits 60 in the entire screen (the entire display panel 6).

Firstly, the processing in the case where the pixel circuits 60 each shown in FIG. 2 are driven for 2D display by the conventional method is described in detail.

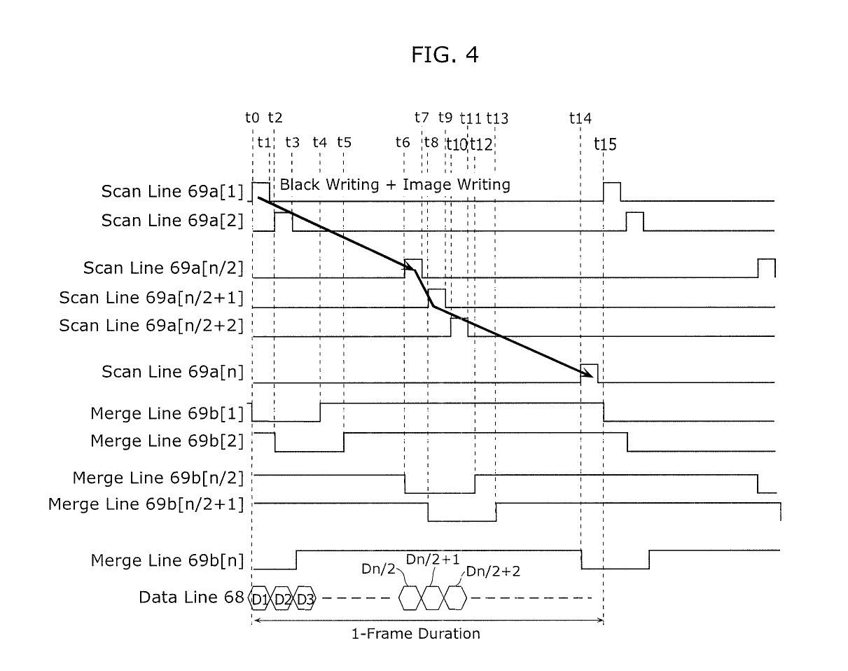

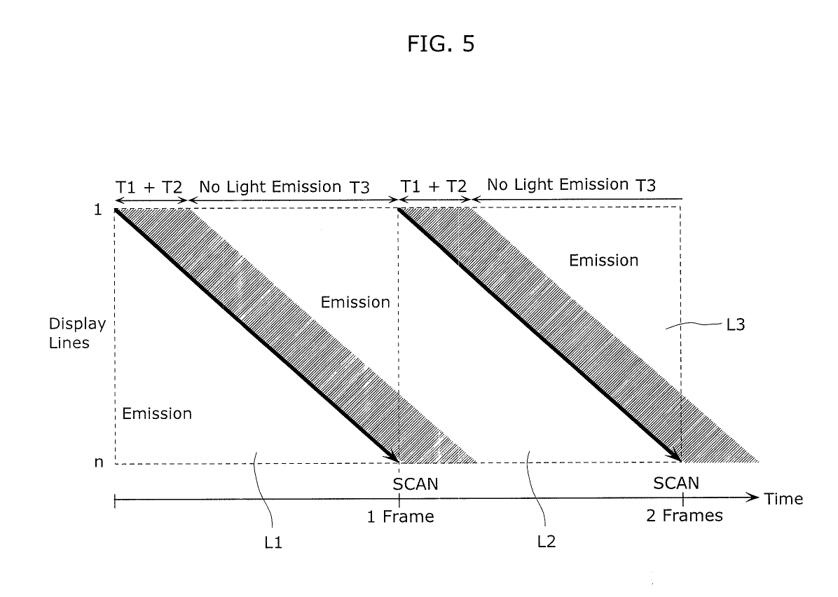

FIG. 4 is a time chart for explaining an example of the processing performed by the display device having the pixel circuits 60 each shown in FIG. 2 in 2D display driving. FIG. 5 is a diagram showing an example of a light emission pattern in the 2D display driving shown in FIG. 4.

In FIG. 4, a horizontal axis expresses a time. In the horizontal axis direction, respective waveforms of voltages at the scan lines 69a (scan lines 69a[1] to 69[n]) and the merge lines 69b (merge lines 69b[1] to 69b[n]) which correspond to respective n display lines of the pixel circuits 60 in the display panel 6. FIG. 4 also shows data signal voltages (from D1) applied to the display panel 6 via the data line 68. In FIG. 5, a horizontal axis expresses a time. A vertical axis of FIG. 5 expresses pixel circuits 60 in a corresponding row (display line) from among the n display lines in the display panel 6. FIG. 5 shows a light emission pattern in the case where scan is performed in a 1-frame duration in 2D display driving. Here, “No Light Emission” in FIG. 5 indicates that a target pixel circuit 60 in the corresponding row (display line) does not emit light, and corresponds to a duration that is a combination of the above-described writing duration T1 and non-lighting duration T2. “Light Emission” in FIG. 5 indicates that a target pixel circuit 60 in the corresponding row emit light, and corresponds to the above-described lighting duration T3 (light-emission duration).

As shown in FIG. 4, the display panel control circuit 2 sequentially scans the pixel circuits 60 in the n display lines included in the display panel 6.

More specifically, from time t₀ to time t₁ in a 1-frame duration, the display panel control circuit 2 performs a process of a writing duration T1 on a target pixel circuit 60 in the first row (the first display line). Next, from time t₂ to time t₄, the display panel control circuit 2 performs a process of a non-lighting duration T2 on the target pixel circuit 60 in the first row. Finally, from time t₄ to time t₁₅, the display panel control circuit 2 performs a process of a non-lighting duration T3 on the target pixel circuit 60 in the first row.

Furthermore, from time t₂ to time t₃ in the 1-frame duration, the display panel control circuit 2 performs a process of a writing duration T1 on the other target pixel circuit 60 in the second row (the second display line). Next, from time t₂ to time t₅, the display panel control circuit 2 performs a process of a non-lighting duration T2 on the target pixel circuit 60 in the second row. Finally, from time t₅, the display panel control circuit 2 performs a process of a non-lighting duration T3 on the target pixel circuit 60 in the second row.

In the above-described manner, the display panel control circuit 2 sequentially scans remaining pixel circuits 60 in the display panel 6 sequentially from the third row (the third display line). As described above, in a writing duration T1 for a target pixel circuit 60 in a target row (display line), a time of setting High a scan signal (scan line 69a[n]) is in synchronization with a time of setting Low a merge signal (merge line 69b[n]).

Thus, the display panel control circuit 2 sequentially scans the pixel circuits 60 in the n display lines included in the display panel 6. In other words, the display panel control circuit 2 performs a process of a writing duration T1, a process of a non-lighting duration T2, and a process of a lighting duration T3 on each of the pixel circuits 60 arranged in the n display lines in the display panel 6. As a result, the light emission pattern as shown in FIG. 5 is obtained.

It should be noted that the scan method for obtaining the emission pattern as shown in FIG. 5 is not enough to offer 3D display. For 3D display, light emission having a left-eye display pattern and light emission having a right-eye display pattern are performed alternately to be perceived alternately by human eyes through glasses or the like.

The following describes the characteristic scan method (driving method) for 3D display in detail.

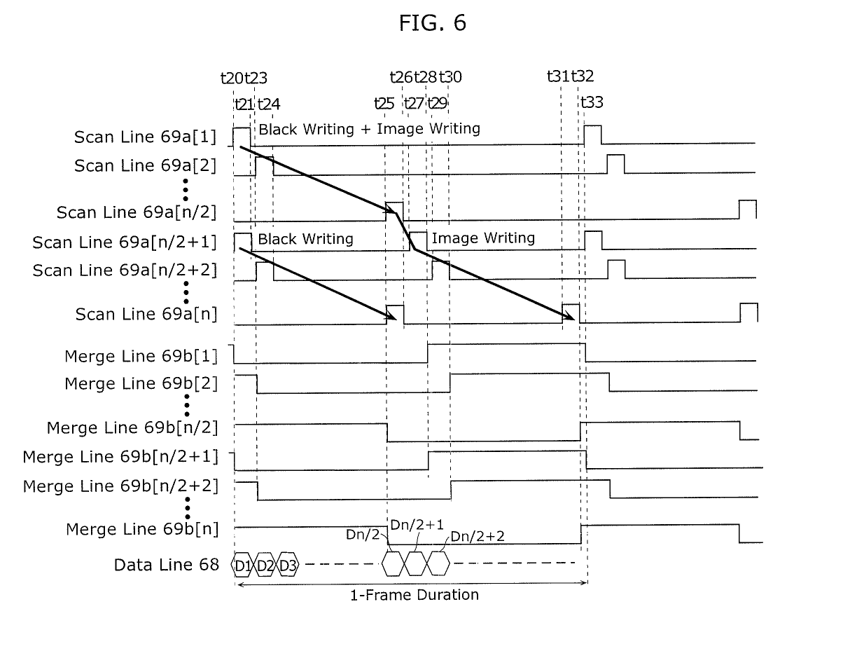

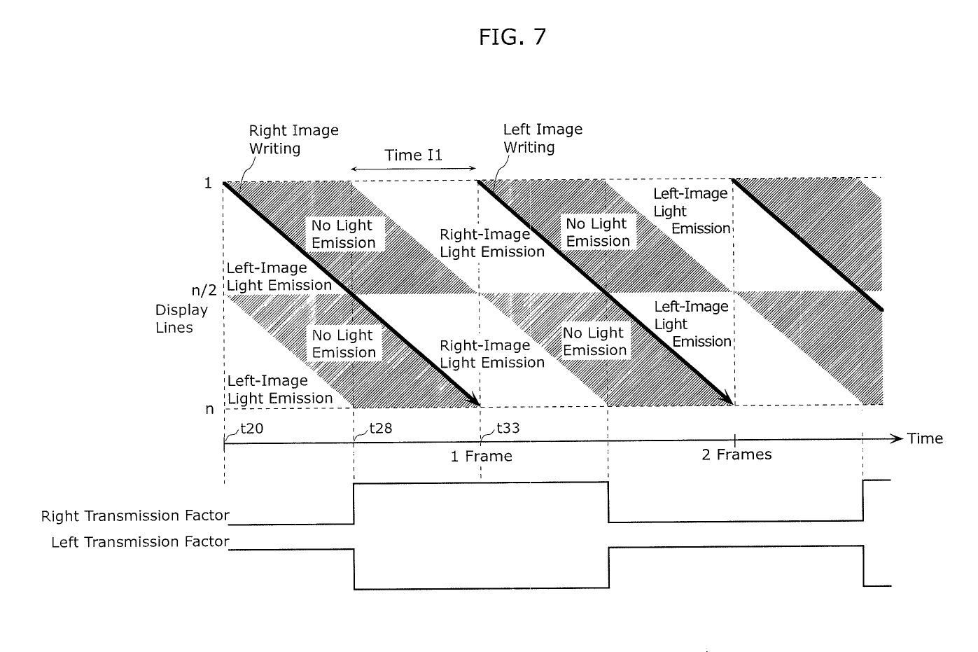

FIG. 6 is a time chart for explaining an example of processing performed by the display device in 3D display driving, according to Embodiment 1. FIG. 7 is a diagram showing an example of a light emission pattern in 3D display driving of the display device according to Embodiment 1. Here, a vertical axis and a horizontal axis in FIG. 6 are the same as those in FIG. 4, and they are therefore not described again below. Likewise, a vertical axis and a horizontal axis in FIG. 7 are the same as those in FIG. 5, and they are therefore not described again below. Each of FIGS. 6 and 7 shows an example situation where the display panel 6 (screen) is divided into two blocks and scanning is performed on the both blocks sequentially from respective top rows. More specifically, the display panel 6 (screen) is divided into an upper block (upper half) and a lower block (lower half), and scanning is performed on both blocks sequentially from respective top rows.

The structure of the pixel circuit 60 shown in FIG. 2 enables the characteristic scan method (driving method) according to the present embodiment to be realized. First, from among the pixel circuits 60 in the n rows (hereinafter, referred to also as display lines) included in the display panel 6, the scan line driving circuit 3 scans (sets a scan signal to High) (a) a target pixel circuit 60 of pixel circuits 60 in a row which receives a corresponding data signal voltage and also (b) another target pixel circuit 60 of pixel circuits 60 in a different row at the same time. Then, when a different corresponding data signal voltage is to be inputted into the other target pixel circuit 60 in the different row (display line) from among the display lines, the scan line driving circuit 3 scans the different row again (sets a scan signal to High). In other words, in the present embodiment, for each of the first to n/2-th rows (display lines in the upper half), scanning is performed only once on the target pixel circuit 60 in the row receiving the corresponding data signal voltage. On the other hand, for each of the n/2+1-th to n-th rows (display lines in the lower half), scanning is performed twice on the other target pixel circuit 60 in the different row receiving the different corresponding data signal voltage, when the row in the first to n/2-th rows (display lines in the upper half) is to be scanned and when the corresponding data signal voltage is to be applied to the target pixel circuit 60 in the row. It should be noted that the above-described processing for the target pixel circuit 60 and the other target pixel circuit 60 is performed for all of the pixel circuits 60 in the row and all of the pixel circuits 60 in the different row, and that the processing for the row and the different row is performed sequentially for all pairs (row and different row) of the n rows.

As described above, for each of display lines in the lower half from among the display lines, a scan line 69a is scanned twice in a 1-frame duration. As a result, it is possible to cause a state of no light emission 53 prior to image writing in the lower half, thereby shifting a light-emission duration phase from that of the upper half.

The following describes the above method in more detail with reference to FIG. 6.

First, from time t₂₀ to time t₂₁ in a 1-frame duration, the display panel control circuit 2 performs a process of a writing duration T1 on a target pixel circuit 60 in the first row, and also performs a process of a first writing duration T1 (in other words, a part of a writing duration T1) on a target pixel circuit 60 in the n/2+1-th row.

More specifically, the data line driving circuit 5 writes (applies) a data signal voltage (D1, for example), such as a gradation voltage corresponding to display gradation, into the target pixel circuit 60 in the first row via the data line 68.

Here, the scan line driving circuit 3 sets High a scan signal applied to the scan line 69a corresponding to the target pixel circuit 60 in the first row, thereby causing the switch 62a and the switch 62b in the target pixel circuit 60 to be conductive. As a result, at both ends of a storage capacitor 63 in the target pixel circuit 60 in the first row, a node A (first electrode) receives a reference voltage (black signal voltage) via the reference voltage power line 65, while a node B (second electrode) receives the data signal voltage (D1) via the data line 68. At time t₂₀, the scan line driving circuit 3 sets Low a merge applied to a merge line 69b corresponding to the target pixel circuit 60 in the first row, thereby causing a switch 62c in the target pixel circuit 60 to be non-conductive. As a result, the data signal voltage (D1) is more likely to be written into the node B via the data line 68 in the target pixel circuit 60 in the first row, and the data signal voltage (D1) is prevented from causing a current to flow in the EL element 64 via the data line 68.

Here, the application of the reference voltage (black signal voltage) to the node A in the target pixel circuit 60 in the first row means application of the reference voltage (black signal voltage) to the gate of the driving transistor 61 in the target pixel circuit 60 in the first row. It is therefore possible to reset a voltage remaining at the gate of the driving transistor 61, and also completely stop the light emission of the EL element 64. In other words, the application of the reference voltage (black signal voltage) to the gate of the driving transistor 61 in each of the pixel circuits 60 in the first row means causing of the EL element to perform black display. Hereinafter, the application of the reference voltage (black signal voltage) to the gate of the driving transistor 61 in the target pixel circuit 60 in the first row is referred to as black writing (or black addition).

On the other hand, the node B in the target pixel circuit 60 in the first row receives the data signal voltage (D1) via the data line 68. With reference to the structure of the pixel circuit 60 shown in FIG. 2, in the target pixel circuit 60 in the first row, the node A receives the reference voltage (black signal voltage) and the pixel circuit 60 therefore can perform black writing. At the same time, the node B receives the data signal voltage (D1). This means that the target pixel circuit 60 in the first row can perform black writing and data signal voltage (D1) writing (image writing) simultaneously in a duration from time t₂₀ to time t₂₁.

From time t₂₀ to time t₂₁, the first process of a writing duration T1 (a part of a writing duration T1) is performed on another target pixel circuit 60 in the n/2+1-th row. More specifically, the scan line driving circuit 3 sets High a scan signal applied to a scan line 69a corresponding to the target pixel circuit 60 in the n/2+1-th row, thereby causing the switch 62a and the switch 62b in the target pixel circuit 60 in the n/2+1-th row to be conductive. At time t₂₀, the scan line driving circuit 3 sets Low a merge signal applied to a merge line 69b corresponding to the target pixel circuit 60 in the n/2+1-th row, thereby causing a switch 62c in the target pixel circuit 60 in the n/2+1-th row to be non-conductive. As a result, in the target pixel circuit 60 in the n/2+1-th row, the node A receives the reference voltage (black signal voltage) via the reference voltage power line 65, and the pixel circuit 60 thereby performs black writing.

Next, from time t₂₇ to time t₂₈, the display panel control circuit 2 performs the second process of a writing duration T1 (in other words, a remaining part of the writing duration T1) on the target pixel circuit 60 in the n/2+1-th row. More specifically, the scan row driving circuit 3 sets High again an signal applied to the scan line 69a corresponding to the target pixel circuit 60 in the n/2+1-th row, thereby causing the switch 62a and the switch 62b in the target pixel circuit 60 in the n/2+1-th row to be conductive. Since time t₂₀, including a duration from time t₂₇ to time t₂₈, the scan line driving circuit 3 keeps Low the merge signal applied to the merge line 69b corresponding to the target pixel circuit 60 in the n/2+1-th row. In other words, from time t₂₀ until time t₂₈, the scan line driving circuit 3 keeps the switch 62c in the target pixel circuit 60 in the n/2+1-th row being non-conductive. As a result, a data signal voltage (Dn/2+1) is written into the target pixel circuit 60 in the n/2+1-th row (image writing is performed).

Next, from time t₂₈ to time t₃₂, the display panel control circuit 2 performs a process of a lighting duration 3 (namely, light-emission duration) on the target pixel circuits 60 both in the first and n/2+1-th rows. More specifically, from time t₂₈ to time t₃₂, the scan line driving circuit 3 keeps Low (a) a scan signal applied to the scan line 69a corresponding to the target pixel circuit 60 in the first row and (b) a scan signal applied to the scan line 69a corresponding to the target pixel circuit 60 in the n/2+1-th row. In other words, the scan line driving circuit 3 keeps the switch 62a and the switch 62b being non-conductive in both rows. In the same duration from time t₂₈ to time t₃₂, the scan line driving circuit 3 sets High (a) a merge signal applied to the merge line 69b corresponding to the target pixel circuit 60 in the first row (a) a merge signal applied to the merge line 69b corresponding to the target pixel circuit 60 in the n/2+1-th row. As a result, the scan line driving circuit 3 causes the switch 62c in the target pixel circuits 60 in both the first and n/2+1-th rows to be conductive.

Therefore, in the target pixel circuit 60 in the first row, the voltage (data signal voltage (D1)) at the node B is applied to the source of the driving transistor 61, and a drain current flows in the driving transistor 61 according to the voltage at the storage capacitor 63. Then, the drain current enters the EL element 64 to cause the EL element 64 to emit light having gradation according to the data signal voltage (D1). Likewise, in the target pixel circuit 60 in the n/2+1-th row, the voltage (data signal voltage (Dn/2+1)) at the node B is applied to the source of the driving transistor 61, and a drain current flows in the driving transistor 61 according to the voltage at the storage capacitor 63. Then, the drain current enters the EL element 64 to cause the EL element 64 to emit light having gradation according to the data signal voltage (D1/2+1).

The display panel control circuit 2 performs the same characteristic driving (scanning and light emission) sequentially on remaining pixel circuits 60 in the target rows. This processing is performed sequentially on the rows from the second row and in the rows from the n/2+2-th row which are included in the display panel 6. It should be noted that, for (a) a target pixel circuit 60 in a target row for which black writing and image writing are performed and (b) the other target pixel circuit 60 in the other target row for which only black writing is simultaneously performed, not only a time of setting High a scan signal for starting black writing but also a time of setting Low a merge signal for starting light emission is synchronized between these rows.

Furthermore, for pixel circuits 60 in the second to n/2-th rows (display lines in the upper half) included in the display panel 6, the display panel control circuit 2 sequentially performs scanning from time t₂₃ to time t₂₄, . . . , and from time t₂₅ to time t₂₆. Likewise, for pixel circuits 60 in the n/2+2-th to n-th rows (display lines in the lower half) included in the display panel 6, the display panel control circuit 2 performs black writing and then image writing sequentially. More specifically, the black writing is performed sequentially from time t₂₃ to time t₂₄, . . . , from time t₂₅ to time t₂₆, and then the image writing is performed sequentially from time t₂₇ to time t₂₈, . . . , from time t₂₉ to time t₃₀, . . . , from time t₃₁ to time t₃₂.

As described above, the characteristic scan method (driving method) according to the present embodiment is performed. As a result, the light emission pattern as shown in FIG. 7 is obtained.

As described above, with the above-described structure of the pixel circuit 60 shown in FIG. 2, a duration is given to simultaneously (a) set High a scan signal applied to a target scan line 69a and (b) set Low a merge signal applied to a target merge line 69b. As a result, black display can be performed while the merge line 69b is Low. Here, since the gate of the switch 62b is ON, there is a possibility that the target pixel circuit 60 receives a data signal voltage (data signal) not corresponding to the target pixel circuit via the data line 68. However, since the gate of the switch 62c is OFF, the node A receives the reference voltage regardless of the voltage (data signal voltage) at the node B, and the EL element 64 therefore performs black display.

As described above, the characteristic scan method (driving method) according to the present embodiment employs the characteristics of the pixel circuits 60, in other words, characteristics by which black display can be performed by receiving the reference voltage at the node A regardless of the voltage (data signal voltage) at the node B.

More specifically, each of the pixel circuits 60 in display lines in the lower half (lines from n/2+1-th row) performs black writing and image writing separately. For each of pixel circuits 60 in display lines in the lower half, driving is performed to execute the first scanning of the scan line 69a at the start of a non-light-emission duration, and to execute the second scanning of the scan line 69a in synchronization with receiving of a corresponding data signal voltage.

Thereby, as shown in FIGS. 6 and 7, each of the pixel circuits in the display lines in the lower half can perform black writing and then image writing, and can keep a non-light-emission state until a high merge signal is applied to a corresponding merge line 69. More specifically, for each of the pixel circuits 60 in the display lines in the lower half, while a merge signal applied to a corresponding merge line 69b is Low, black writing has been performed and completed by setting High a scan signal applied to a corresponding scan line 69a, and after that, image writing has been performed and completed by receiving a corresponding data signal voltage via the data line 68. The non-light-emission state is kept until the merge signal applied to the merge line 69b is changed to High.

On the other hand, for each of the pixel circuits 60 in the display lines in the upper half, black writing and image writing are performed simultaneously. More specifically, in the upper half, a target pixel circuit 60 in a display line corresponding to a target display line in the lower half is driven to scan a corresponding scan line 69a at the start of the above-described non-light-emission duration. In more detail, while a merge signal applied to a corresponding merge line 69b is Low, the target pixel circuit 60 in the corresponding display line in the upper half performs black writing by setting High a scan signal applied to a corresponding scan line 69a, and also performs image writing by receiving a corresponding data signal voltage via the data line 68. The non-light-emission state is kept until the merge signal applied to the merge line 69b is changed to High.

As described above, in the characteristic scan method (driving method) according to the present embodiment, for arbitral two rows (display lines) corresponding to each other, scanning starts when the non-light-emission duration starts. As a result, as shown in FIG. 7, on the same time axis, a target pixel circuit 60 in a target display line in the upper half and a target pixel circuit 60 in a corresponding display line in the lower half can start respective non-light-emission durations at the same time, and end the durations at the same time.

Next, as described above, on the same time axis, a target pixel circuit 60 in the target display line in the upper half and a target pixel circuit 60 in the corresponding display line in the lower half start respective light-emission durations at the same time. Here, each of the target pixel circuit 60 in the target display line in the upper half and the target pixel circuit 60 in the corresponding display line in the lower half needs to store (hold) a data signal voltage indicating a corresponding gradation into a corresponding storage capacitor 63. Into the target pixel circuit 60 in the target display line in the upper half, a corresponding data signal voltage is written when the scan line 69a is scanned. However, into the target pixel circuit 60 in the corresponding display line in the lower half, a data signal voltage indicating gradation different from that for the target upper display line is written. However, as described above, since the node A in the target pixel circuit 60 receives the reference voltage regardless of the voltage (data signal voltage) at the node B, the pixel circuit 60 can keep black display. While the black display is kept (non-light-emission duration), for the target pixel circuit 60 in the corresponding display line in the lower half, the scan line 69a is scanned again as shown in FIG. 6 in order to write a data signal voltage indicating a corresponding desired gradation is written (image writing is performed).

Then, after completing the image writing, (a) a merge line 69b corresponding to a target pixel circuit 60 in the target display line in the upper half and (b) a merge line 69b corresponding to the other target pixel circuit 60 in the corresponding display line in the lower half are set High.

As a result, on the same time axis as shown in FIG. 7, the target pixel circuit 60 in the target display line in the upper half and the pixel circuit 60 in the corresponding display line in the lower half start respective light-emission states (respective light-emission durations) at the same time.

As described above, the target pixel circuit 60 in the target display line in the upper half and the pixel circuit 60 in the corresponding display line in the lower half start respective light-emission durations in synchronization with each other, thereby matching luminance. The target pixel circuit 60 in the target display line in the upper half does not perform the second scanning on the scan line 69a, because image writing has already been performed and no further image writing is necessary. It is only necessary to set a duration in which a merge signal to the merge line 69b is High, to be equal to that in the corresponding display line in the lower half.

Here, the processing from writing to light emission is performed sequentially on a target pixel circuit 60 in a target display line in the upper half and a pixel circuit 60 in a corresponding display line in the lower half, according to respective corresponding data signal voltages applied via the respective data lines 68.

In the above-described manner, light-emission states and non-light-emission states can be realized as shown in FIG. 7. More specifically, it is possible to prevent that a light-emission duration for a left-eye image and a light-emission duration for a right-eye image temporally overlap each other. As a result, respective transmission factors of the left and right glasses of the shutter glasses 8 are switched as shown in FIG. 7 to perform 3D display.

As described above, Embodiment 1 can provide a display device capable of displaying 3D images, keeping the same light-emission duration as the conventional one without increasing a writing speed, and also provide a method of driving the display device.

More specifically, by the driving method according to Embodiment 1, the display panel 6 (screen) is divided into two blocks and scanning is performed on both blocks sequentially from respective top rows (display lines).

More specifically, the display device 1 includes a plurality of luminescence pixels arranged in a matrix. Each of the luminescence pixels has a light-emission duration in which the luminescence pixel emits light and a non-light-emission duration in which the luminescence pixel does not emit light. The display device 1 applies a black signal voltage sequentially to target pixel circuits 20 in each pair of the rows (display lines). It is therefore possible to start respective non-light-emission durations for the target pixel circuits in the two rows in the target pair at the same time, thereby preventing the target pixel circuits 60 in the two rows from emitting light. Furthermore, at the time of applying the black signal voltage (at the start of the respective non-light-emission durations), the display device 1 writes a corresponding data signal voltage to a target pixel circuit 60 in one row in the pair. Next, after applying the black signal voltage, the display device 1 writes a corresponding data signal voltage to the other target pixel circuit 60 in the other row in the pair. After having written the data signal voltage to the other target pixel circuit 60, the display device 1 ends the non-light-emission durations of the two target pixel circuits 60. Then, at the time of completing the non-light-emission durations, the display device 1 causes the two target pixel circuits 60 in the two rows to emit light at the same time, based on the respective data signal voltages written in the target pixel circuits 60 in the two rows. Therefore, the light-emission durations of the luminescence pixels in the two rows start at the same time. Here, the pixel circuits 60 in one of the two rows belong to one of the upper half and the lower half of the display panel 4. The pixel circuits 60 in the other one of the two rows belong to the other one of the upper half and the lower half of the display panel 4.

It should be noted that FIG. 7 shows an ideal situation without signal deformation in the gate signal line or the like. Therefore, in FIG. 7, after applying a black signal voltage, the display device 1 writes a corresponding data signal voltage into a target pixel circuit 60 in the other one of the two rows, and at completion of the writing of the corresponding data signal voltage, ends the non-light-emission duration of the target pixel circuit 60. In practice, however, signal deformation in the gate signal line or the like occurs. In order to prevent such signal deformation from causing simultaneous ON (ending a non-light-emission duration and starting a light-emission duration at the same time), each of the scan line 69a and the merge line 69b has an OFF duration.

It should be noted that it has described that, by the driving method according to Embodiment 1, the display panel 6 (screen) is divided into two blocks and scanning is performed on both blocks sequentially from respective top rows (display lines). However, the present invention is not limited to the above. Scanning may start from respective bottom rows (display lines) of both divided blocks.

It should also be noted that the 3D display driving using the driving method according to Embodiment 1 has advantages that the driving method shown in FIG. 6 is possible when the gate driver included in the scan line driving circuit 3 is divided into two blocks and a start pulse is given to each of the blocks. It is therefore possible to perform the 3D driving method according to Embodiment 1 without increasing a circuit size of the gate driver. As a result, a cost of manufacturing the gate driver is hardly different from the conventional cost. An example of the gate driver included in the scan line driving circuit 3 is given below.

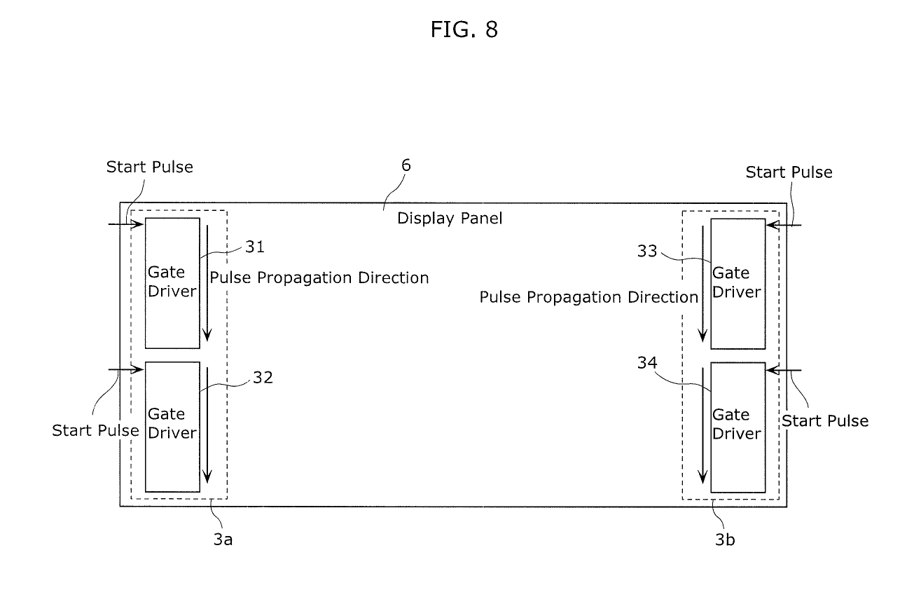

FIG. 8 is a diagram showing an example of the gate driver included in the scan line driving circuit according to Embodiment 1. The display panel 6 includes a scan line driving circuit 3a and a scan line driving circuit 3b. The scan line driving circuit 3a includes a gate driver 31 and a gate driver 32. The scan line driving circuit 3b includes a gate driver 33 and a gate driver 34.

If the gate driver circuits (the gate drivers 31 to 34) are formed on the display panel 6 as shown in FIG. 8, the circuits can be manufactured without increasing a size of the outer frame of the display panel 6. Therefore, it is possible to implement a display device having a narrow outer frame.

It should also be noted that the characteristic scanning method (driving method) according to the present embodiment is used not only for 3D display driving. It can be used also for 2D display driving. More specifically, when 2D display driving is to be performed by using the gate driver circuits shown in FIG. 8, a start pulse is given to the gate driver 32 at the time of completing pulse propagation to the gate driver 31, without giving a start pulse to the gate drivers 31 and 32 at the same time. Therefore, in the case of 2D display driving, 2D display is also performed only by using an input signal pattern different from that in the 3D display driving.

It is also possible that 3D display driving is performed by the characteristic scanning method (driving method) according to the present embodiment, and 2D display driving is performed by changing the driving method to the driving method shown in FIG. 4.

(Variation)

According to Embodiment 1, it has been described that a time required for glass switching of the shutter glasses 8 (changing of transmission factors) is almost 0. However, for example, if liquid crystal shutters are used in the shutter glasses 8, it takes about 1 ms to 2 ms to switch between the shutters. In this case, in switching the shutter glasses 8, there is a time during which both eyes can perceive the display panel 6. As a result, there is a possibility that crosstalk phenomenon occurs.

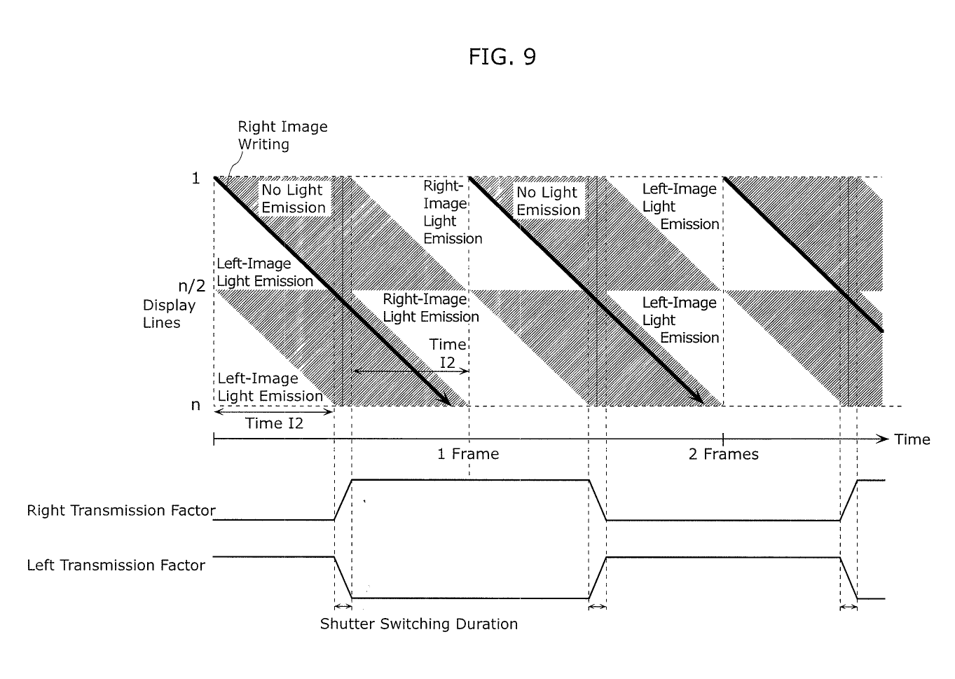

In order to prevent crosstalk phenomenon, the present variation provides a technique, as shown in FIG. 9, of adding a shutter switch duration to switch between the shutters, and driving all of the display lines in the display panel 6 not to emit light in the shutter switch duration as described below.

FIG. 9 is a diagram showing an example of a light emission pattern in 3D display driving of a display device according to a variation of Embodiment 1. A vertical axis and a horizontal axis in FIG. 9 are the same as those in FIG. 7, and they are therefore not described again below.

In the present variation, like the light emission pattern shown in FIG. 9, in a shutter switch duration, the entire display screen is driven to be in a non-light-emission duration. This is achieved by decreasing a scan duration per row (display line) by 10% to 20% from the light emission pattern shown in FIG. 7.

As a result, it is possible to increase a speed of scanning the scan line 69a and the merge line 69b. In more detail, a duration 12 from when all of the display lines start emitting light (when the entire screen is turned to light) to when all of the display lines are caused not to emit light (when the entire screen is turned off the light) is shorter than the duration 11 in FIG. 7. A duration from when the entire screen is turned off the light to when the entire screen is turned to light is also shorter than a corresponding duration in FIG. 7.

If a duration twice as long as the duration 12 is shorter by 1 ms to 2 ms than the 1-frame length, it is possible to add a non-light-emission duration in every display line in the entire screen as seen in FIG. 9.

Therefore, when a non-light-emission duration for each of the display lines in the entire screens includes a shutter switching duration, it is possible to perform 3D display without crosstalk, even if the shutter glasses 8 needs a time for shutter switching.

In addition, a duration in which the merge signal applied to the merge line 69b is Low is longer than a corresponding duration in FIG. 7. This is because all of the display lines do not emit light. More specifically, after writing an image signal to a target pixel circuit 60 in a target row (display line) in the lower half, the merge signal applied to the corresponding merge line 69b is kept Low until the shutter switch duration has passed. As a result, it is possible to cause all of the display lines not to emit light in a shutter switch duration.

### Embodiment 2

It has been described in Embodiment 1, as an example of dividing the display panel 6 (screen) into two blocks and scanning both blocks sequentially from respective top rows (display lines), that the display panel 6 (screen) is divided into an upper half and a lower half. In Embodiment 2, however, as another example of dividing the display panel 6 (screen) into two parts, the display panel 6 (screen) is divided to a screen including odd rows and a screen including even rows. It is also possible to switch the screen including odd rows and the screen including even rows. The following describes an example case where the display panel 6 (screen) is divided into a screen including odd rows and a screen including even rows.

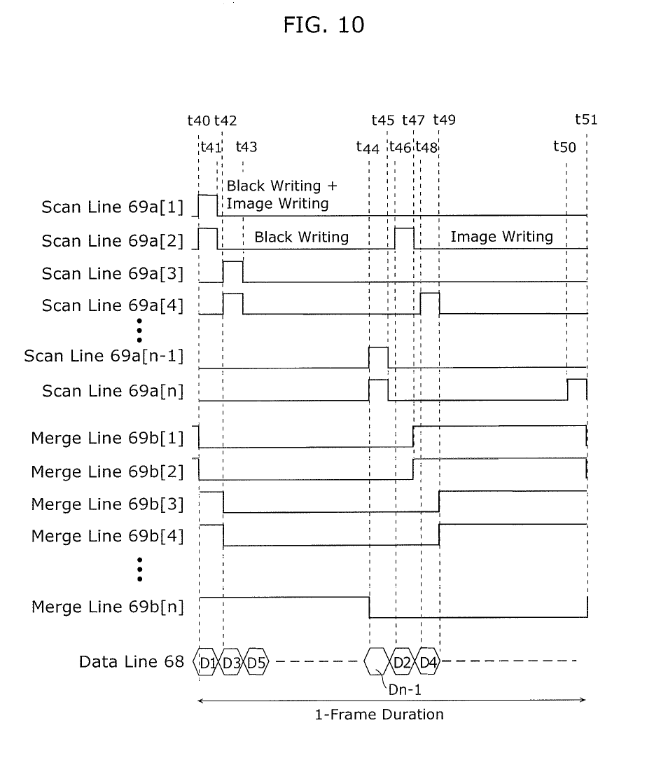

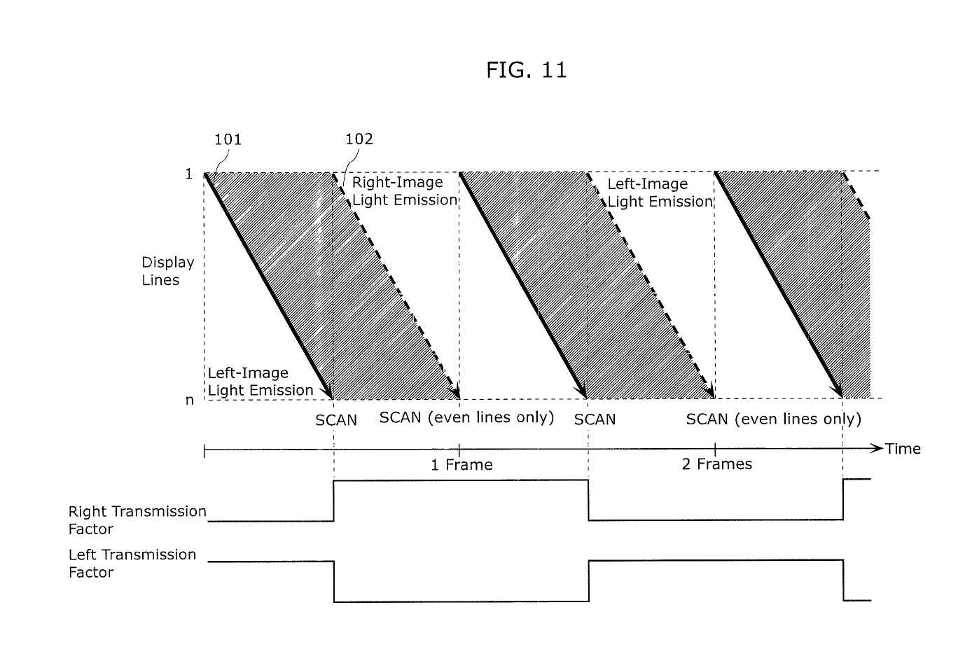

FIG. 10 is a time chart showing an example of processing performed by a display device in 3D display driving, according to Embodiment 2. FIG. 11 is a diagram showing an example of a light emission pattern in the 3D display driving of the display device according to Embodiment 2. Here, a vertical axis and a horizontal axis in FIG. 10 are the same as those in FIG. 4, and they are therefore not described again below. Likewise, a vertical axis and a horizontal axis in FIG. 11 are the same as those in FIG. 5, and they are therefore not described again below.

As shown in FIG. 10, a display panel control circuit 2 according to, the present embodiment performs writing via the scan line 69a sequentially on pairs of adjacent rows. It is characterized in that for each of the odd rows, image writing and black writing are performed at the same time, while for each of the even rows, only black writing is performed.

An operation of a light-emission duration which is caused by a merge line 69b is in synchronization with an operation by a scan line 69a. In other words, the display panel control circuit 2 according to the present embodiment drives respective merge signals to be applied to target merge lines 69b for a pair of adjacent two rows, thereby producing identical waveforms. A transfer order via a data line 68 is also different from that in Embodiment 1. In synchronization with a scan line 69a, a data signal voltage (data signal) is transferred via the data line 68 to the other target pixel circuit 60 in a corresponding even row, after transferring a data signal to a target pixel circuit 60 in an odd row.

More specifically, first, from time t₄₀ to time t₄₁ in a 1-frame duration, the display panel control circuit 2 performs a process of a writing duration T1 on a target pixel circuit 60 in the first row, and also performs a process of a first writing duration T1 (in other words, a part of a writing duration T1) on the other target pixel circuit 60 in the second row.

More specifically, the data line driving circuit 5 writes (applies) a data signal voltage (D1, for example), such as a gradation voltage corresponding to display gradation, into a target pixel circuit 60 in the first row via the data line 68.

Here, the scan line driving circuit 3 sets High a scan signal applied to the scan line 69a corresponding to the target pixel circuit 60 in the first row, thereby causing the switch 62a and the switch 62b in the target pixel circuit 60 to be conductive. As a result, at both ends of a storage capacitor 63 in the target pixel circuit 60 in the first row, a node A receives a reference voltage (black signal voltage) via the reference voltage power line 65, while a node B receives the data signal voltage (D1) via the data line 68. At time t₂₀, the scan line driving circuit 3 sets Low a merge signal applied to a merge line 69b corresponding to the target pixel circuit 60 in the first row, thereby causing a switch 62c in the target pixel circuit 60 to be non-conductive.

From time t₄₀ to time t₄₁, the first process of a writing duration T1 (a part of a writing duration T1) is performed on the target pixel circuit 60 in the second row. More specifically, the scan line driving circuit 3 sets High a scan signal applied to a scan line 69a corresponding to the target pixel circuit 60 in the second row, thereby causing the switch 62a and the switch 62b in the target pixel circuit 60 in the second row to be conductive. At time t₄₀, the scan line driving circuit 3 sets Low a merge signal applied to a merge line 69b corresponding to the target pixel circuit 60 in the second row, thereby causing a switch 62c in the target pixel circuit 60 in the second row to be non-conductive. As a result, in the target pixel circuit 60 in the second row, the node point A receives the reference voltage via the reference voltage power line 65 and black writing is thereby performed.

Next, from time t₄₆ to time t₄₇, the display panel control circuit 2 performs the second process of a writing duration T1 (in other words, a remaining part of the writing duration T1) on the target pixel circuit 60 in the second row. More specifically, the scan line driving circuit 3 sets High a scan signal applied to a scan line 69a corresponding to the target pixel circuit 60 in the second row, thereby causing the switch 62a and the switch 62b in the target pixel circuit 60 in the second row to be conductive. From time t₄₀ to time t₄₈, the scan line driving circuit 3 keeps Low the merge signal applied to the merge line 69b corresponding to the target pixel circuit 60 in the second row. In other words, from time t₄₀ until time t₄₈, the scan line driving circuit 3 keeps the switch 62c in the target pixel circuit 60 in the second row being non-conductive. As a result, the data signal voltage (Dn) is written into the target pixel circuit 60 in the second row (image writing is performed).

Next, from time t₄₈ to time t₅₁, the display panel control circuit 2 performs a process of a lighting duration 3 (namely, light emission) on the target pixel circuits 60 both in the first and second rows. More specifically, from time t₄₈ to time t₈₁, the scan line driving circuit 3 keeps Low (a) a scan signal applied to the scan line 69a corresponding to the target pixel circuit 60 in the first row and (b) a scan signal applied to the scan line 69a corresponding to the target pixel circuit 60 in the second row. In other words, the scan line driving circuit 3 keeps the switch 62a and the switch 62b being non-conductive in both rows. In the same duration from time t₄₈ to time t₅₁, the scan line driving circuit 3 sets High (a) a merge signal applied to the merge line 69b corresponding to the target pixel circuit 60 in the first row (a) a merge signal applied to the merge line 69b corresponding to the target pixel circuit 60 in the second row. As a result, the scan line driving circuit 3 causes the switch 62c in the target pixel circuits 60 in both the first and second rows to be conductive.

Therefore, in the target pixel circuit 60 in the first row, the voltage (data signal voltage (D1)) at the node B is applied to the source of the driving transistor 61, and a drain current flows in the driving transistor 61 according to the voltage at the storage capacitor 63. Then, the drain current enters the EL element 64 to cause the EL element 64 to emit light having gradation according to the data signal voltage (D1). Likewise, in the target pixel circuit 60 in the second row, the voltage (data signal voltage (D2)) at the node B is applied to the source of the driving transistor 61, and a drain current flows in the driving transistor 61 according to the voltage at the storage capacitor 63. Then, the drain current enters the EL element 64 to cause the EL element 64 to emit light having gradation according to the data signal voltage (D2).

The display panel control circuit 2 performs the same characteristic driving (scanning and light emission) sequentially on remaining pixel circuits 60 in the target pair. This processing is performed sequentially on remaining pairs from a pair of the third and fourth rows which are included in the display panel 6. It should be noted that, for (a) a target pixel circuit 60 in a row on which black writing and image writing are performed and (b) another target pixel circuit 60 in another row on which only black writing is simultaneously performed, not only a time of setting High a scan signal for starting black writing but also a time of setting High a merge signal for starting light emission is synchronized between these rows.

The description for pixel circuits 60 in the pair of the third and fourth rows in the display panel 6 is the same as described above, and therefore not given again below. From time t₄₂ to time t₄₃, a process of a writing duration T1 is performed on a target pixel circuit 60 in the third row, and the first process of a writing duration T1 (a part of a writing duration T1, namely, black writing) is performed on the other target pixel circuit 60 in the fourth row. Then, from time t₄₈ to time t₄₉, the second process of the writing duration T1 (a remaining part of the writing duration T1, namely, image writing) is performed on the target pixel circuit 60 in the fourth row. Sequentially, the above processing is repeated.

As described above, the characteristic scan method (driving method) according to the present embodiment is performed. As a result, right-eye light emission and left-eye light emission do not occur at the same time as shown in FIG. 11.

Here, as shown in FIG. 11, the scanning (SCAN) has been completed in a 1/2-frame duration as shown in FIG. 11. In SCAN 101, at least black writing is performed on adjacent two rows, and in SCAN 102, image writing is performed on only, for example, an even row from among the adjacent two rows. Therefore, a duration required for scanning (SCAN) is a half of the corresponding duration in FIGS. 4 and 5.

More specifically, in SCAN 101, black writing and image writing for respective pixel circuits 60 are performed sequentially for odd rows from a top of the screen, so that a target pixel circuit 60 in a target odd row becomes in a black display state (non-light-emission duration). Here, in synchronization with the process on the odd rows, black writing for respective pixel circuits 60 is performed sequentially for even rows from a top of the screen, so that a target pixel circuit 60 in a target even row adjacent to the target odd row (namely, an even row immediately-below the odd row) becomes in a black display state (non-light-emission duration). Next, in SCAN 102, image writing is performed only the target pixel circuit 60 on the target even row.

Then, after completing the image writing only on the even row in SCAN 102, the adjacent even and odd rows emit light at the same time.

Repetition of the above processing achieves alternative display for the right eye and the left eye. As a result, by synchronizing times of controlling transmission factors of the shutter glasses 8, it is possible to achieve 3D display like Embodiment 1.

According to the present embodiment, it has been described that a time required for glass switching of the shutter glasses 8 (changing of transmission factors) is almost 0. In switching the shutter glasses 8, there is a time during which both eyes can perceive the display panel 6. As a result, there is a possibility that crosstalk phenomenon occurs. In this case, in a shutter switch duration, the entire screen is driven to be in a non-light-emission duration in the same manner as described in the variation of Embodiment 1.

As described above, Embodiment 2 can provide a display device capable of displaying 3D images, keeping the same light-emission duration as the conventional one without increasing a writing speed, and also provide a method of driving the display device.

More specifically, the display device 1 includes a plurality of luminescence pixels arranged in a matrix. Each of the luminescence pixels has a light-emission duration in which the luminescence pixel emits light and a non-light-emission duration in which the luminescence pixel does not emit light. The display device 1 applies a black signal voltage sequentially to each pair of the rows of the pixel circuits 60. It is therefore possible to start respective non-light-emission durations for two rows in the target pair at the same time, thereby preventing pixel circuits 60 in the two rows from emitting light. Furthermore, at the time of starting non-light-emission durations, the display device 1 writes a corresponding data signal voltage to a target pixel circuit 60 in one of the two rows. Next, after applying the black signal voltage, the display device 1 writes a data signal voltage to the other target pixel circuit 60 in the other row of the two rows. After having written the data signal voltage, the display device 1 ends the non-light-emission durations of the two target pixel circuits 60. Then, at the time of completing the non-light-emission durations, the display device 1 causes the target pixel circuits 60 in the two rows to emit light at the same time, based on the respective data signal voltages written in the respective pixel circuits 60 in the two rows. Therefore, the light-emission durations of the target luminescence pixels in the two rows start at the same time. Here, pixel circuits 60 in one of the two rows belong to one of the odd row group and the even row group of the display panel 4. Pixel circuits 60 in the other one of the two rows belong to the other one of the odd row group and the even row group of the display panel 4.

It should be noted that FIG. 11 shows an ideal situation without signal deformation in the gate signal line or the like. Therefore, in FIG. 11, after applying a black signal voltage, the display device 1 writes a data signal voltage to the target pixel circuit 60 in the other one of the two rows, and at completion of the writing of the data signal voltage, ends the non-light-emission durations of the two target pixel circuits 60. In practice, however, signal deformation in the gate signal line or the like occurs. In order to prevent such signal deformation of the gate signal line from causing simultaneous ON (ending a non-light-emission duration and starting a light-emission duration at the same time), each of the scan line 69a and the merge line 69b has an OFF duration.

The driving method according to the present embodiment is characterized, as shown in FIG. 10, in that the same pulse is applied to both the (2m−1)th row and the (2m)th row (where m is a natural number and is equal to or smaller than the number of vertical scan lines). It is therefore possible that gate drivers included in the scan line driving circuit 3 use outputs of the same shift resisters. More specifically, the number of shift registers each of which supplies a merge signal to a corresponding merge line 69b according to the driving method shown in FIG. 10 is only a half of the conventional number. In short, the driving method shown in FIG. 10 can be implemented by a gate driver having a small circuit size.

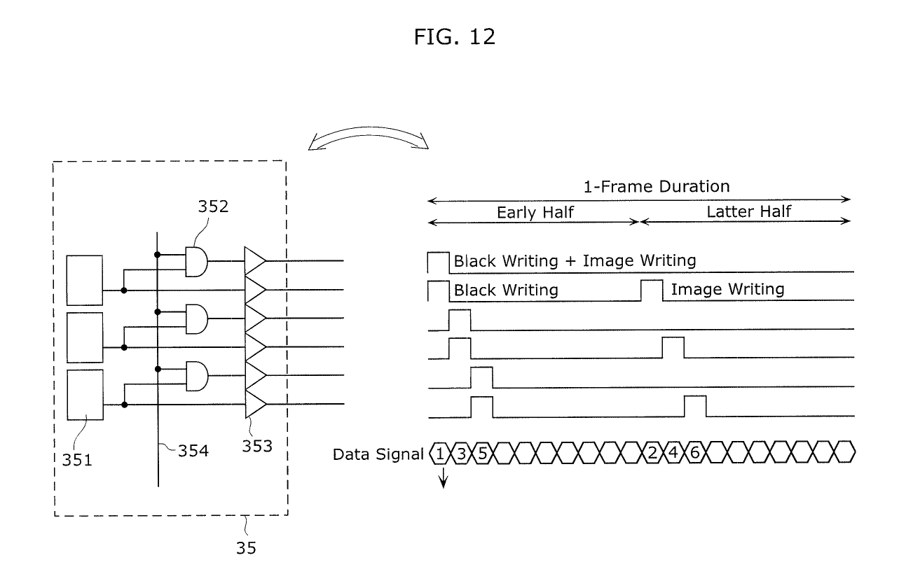

The same goes for a scan signal applied to each scan line 69a. FIG. 12 is a diagram showing an example of the gate driver included in the scan line driving circuit and an example of a 3D display driving waveform of the gate driver, according to Embodiment 2. The gate driver 35 in FIG. 12 includes a plurality of shift register circuits 351, a plurality of mask circuits 352, a plurality of buffer circuits 353, and an enable signal line 354.

For example, as shown in FIG. 12, the gate driver 35 applies the same pulse to both adjacent two rows in an early half of a 1-frame duration, in the same manner as the merge line 69b. In a latter half of the 1-frame duration, however, the gate driver 35 applies a pulse to only an even row in the two rows.

Therefore, a shift register circuit 351 needs only one stage for two display lines as shown in FIG. 12, so that a pulse is applied to an even row. In other words, it is not necessary to provide a shift register circuit 351 to every display line. As a result, it is possible to decrease a total number of the shift register circuits 351. Here, it is possible for the odd row that the enable signal line 354 is used for a corresponding mask circuit 352 in order (i) to apply a pulse to the odd row in synchronization with the even row in the early half of the 1-frame duration, and (ii) not to apply a pulse to the odd row in the latter half of the 1-frame duration.

As described above, the gate driver 35 according to the present embodiment has the shift register circuit stages in a half number in comparison to the conventional gate driver. As a result, the driving method shown in FIG. 10 can decease a circuit size of the gate driver.

Although it has been described that the mask circuits 352 are provided only for odd rows, the present invention is not limited to the structure. For example, if writing is performed on a plurality of data lines 68 by time-sharing a single output of the data line driving circuit 5 (in the case of signal selection driving), there is a case where a pulse is applied to corresponding scan lines 69a only in a part of a horizontal scan duration. In this case, there is a situation where the mask circuits 352 are necessary for all of the display lines. In this situation, the gate driver 35 merely changes a mask duration of the mask circuit 352 between an even row and an odd row. More specifically, two enable signal lines 354 are connected to the mask circuit 352. This structure can realize the above-described driving method without increasing the number of mask circuits 352, and also decrease the number of stages of the shift register circuits 351 to a half. In short, only one additional enable signal lines 354 can achieve the above, thereby reducing the entire circuit size.

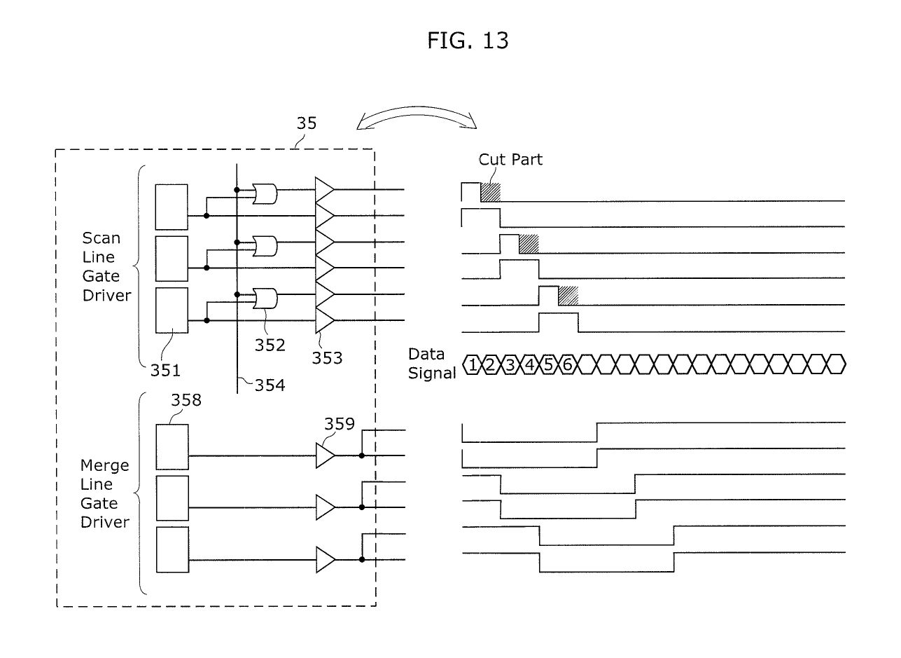

Here, as described with reference to FIG. 12, even if the number of the shift register stages in the gate driver 35 is decreased to a half, 2D display driving as well as 3D display driving can be performed without problem. This will be explained with reference to FIG. 13.

FIG. 13 is a diagram showing another example of the gate driver included in the scan line driving circuit and another example of the 2D display driving waveform of the gate driver, according to Embodiment 2. The same reference numerals in FIG. 12 are assigned to identical structural elements in FIG. 13, and therefore the identical structural elements are not described below. FIG. 13 shows the gate driver 35 that includes a scan signal gate driver for a scan signal and a merge signal gate driver for a merge signal. FIG. 13 also sows driving waveforms of the merge signal gate driver and driving waveforms of the merge signal gate driver. The scan signal gate driver includes a plurality of shift register circuits 351 and a plurality of buffer circuits 353.

In the case of 2D display driving, mask circuits 352 are used to produce driving waveforms of the scan signal gate driver as shown in FIG. 12. Therefore, the same circuit can perform also 2D display driving. On the other hand, the merge signal gate driver sets a merge signal Low, in synchronization with a pulse input (input for setting a scan signal High) of the scan signal as shown in FIG. 12. Then, when writing for two rows has been completed, light emission (lighting) is allowed. Therefore, after performing a non-light-emission operation (black addition) in a predetermined duration, a merge signal is set High to emit light. In other words, the gate driver 35 achieving the 3D display in FIG. 11 needs only to change an input signal pattern to perform 2D display by the same circuit.

As described above, it is possible to reduce a size of the gate driver included in the display device that performs 2D display and 3D display.

### Embodiment 3

In Embodiments 1 and 2, it has been described that the display panel 6 (screen) is divided into two blocks and scanning is performed sequentially from respective top rows of both blocks. In Embodiment 3, the description is given for the case where a direction of scanning is different from that in the above description.

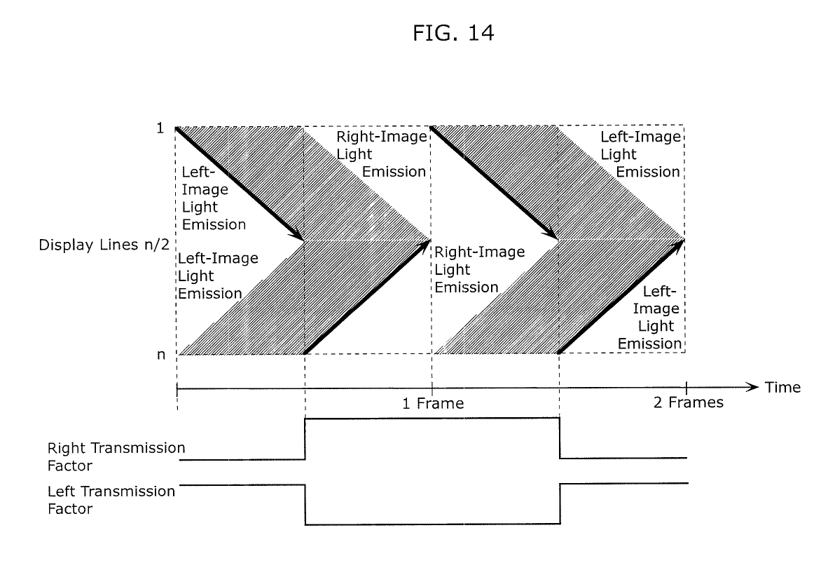

FIG. 14 is a diagram showing an example of a light emission pattern in 3D display driving of a display device according to Embodiment 3.

More specifically, as shown in FIG. 14, the display panel control circuit 2 reverses a scan direction between (a) a row in a block (upper half of the screen) on which image writing and black writing are performed at the same time and (b) a row in a block (lower half of the screen) on which black writing is first performed and then image writing g is performed.

More specifically, the scan line driving circuit 3 sequentially scans display lines in the upper half in a direction from the first row to the n/2-th row, and sequentially scans display lines in the lower half in a direction from the n-th row to the n/2+1-th row. Furthermore, application of the data signal voltages (data signals) from the data line driving circuit 5 is also performed in the direction of scanning the block.

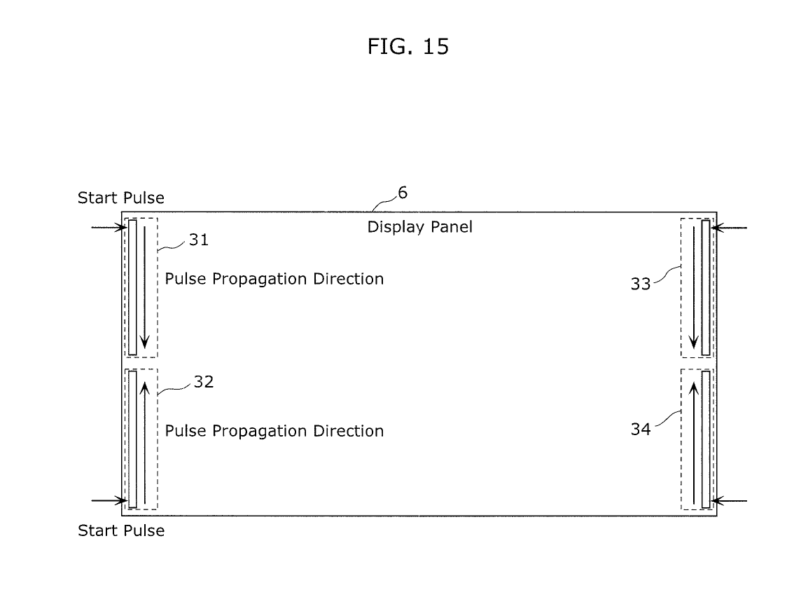

Here, in order to achieve the scanning shown in FIG. 14, a pulse is transmitted as shown in FIG. 15. FIG. 15 is a diagram for explaining a pulse transmission direction of the gate driver included in the scan line driving circuit according to Embodiment 3. Here, the pulse refers to a high scan signal or a high merge signal.

More specifically, as shown in FIG. 15, a start pulse is applied from a panel end to each of gate drivers 31 to 34 in the two divided blocks. Then, the pulse is transmitted towards the center, so that a start pulse is applied from a bottom end of the panel after a 1/2-frame.

As described above, driving is performed by reversing a scan direction between the upper block and the lower block of the display panel 6 (screen). It is thereby possible to prevent that a light emission duration is increased in an adjacent row. Therefore, it is possible to decrease problems that a display pattern such as a horizontal scroll video is shifted along a boundary between the upper part and the lower part separated by the center.

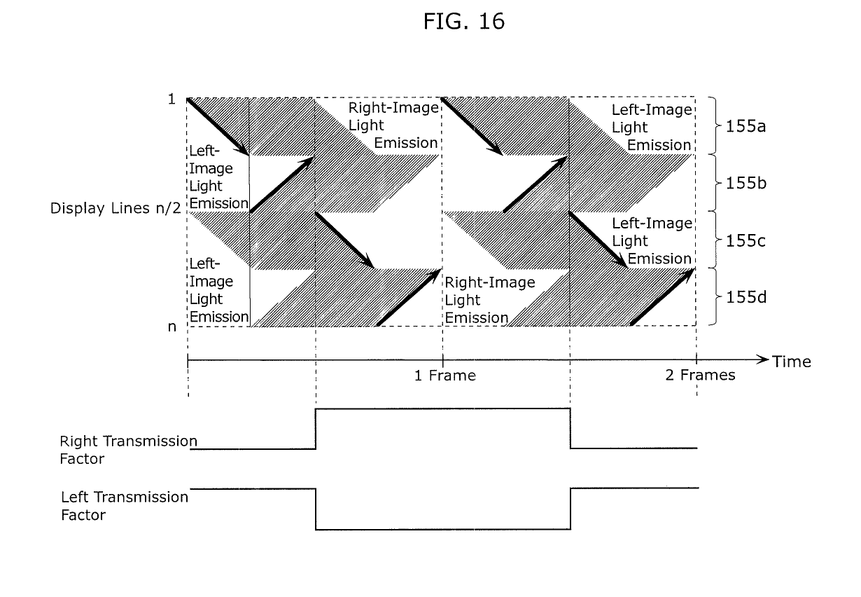

It should be noted that the number of blocks on which scan direction reversing or continuous row scanning is performed is not limited to two. For example, as shown in FIG. 16, the display panel 6 (screen) may be divided into four blocks. FIG. 16 is a diagram showing another example of the light emission pattern in the 3D display driving of the display device according to Embodiment 3.

In this case, for example, a scan line and a merge line are cooperated for blocks 155a and 155c, and for blocks 155b and 155d.

It should be noted that this driving method can be achieved by combining with signal line selection driving used in a small panel. The driving method can be achieved not only by the method of writing a data signal to a data line, such as the vertically dividing driving and the double data line driving, but also by the following method. A data transfer order of transferring data to a data line is sorted according to an order of pixel circuits in a display line on which image writing is performed, and a pulse width of the scan line is adjusted.

Furthermore, the number of blocks on which scan direction reversing or continuous row scanning is performed may be three. Likewise, although it has been described that the number of rows for which an operation of a light-emission duration is performed at the same time is two, but the present invention is not limited to the above. Of course, it is possible to set a light-emission duration for two or more rows at the same time.

As described above, Embodiment 3 can provide a display device capable of displaying 3D images, keeping the same light-emission duration as the conventional one without increasing a writing speed, and also provide a method of driving the display device.

It should be noted that the display device and its driving method according to the present embodiment are not limited to display 3D images, keeping the same light-emission duration as the conventional one without increasing a writing speed. The case where 2D images are displayed by the display device and its driving method is also included in the present invention.

If black addition periods occupy about 50% or more of a non-light-emission duration, it is efficient to perform 2D image display only by using the display device and its driving method according to the present embodiment. More specifically, (1) a visibility is increased (a difference of a lighting duration between an upper part and a lower part of a panel is reduced) if black addition periods occupy about 50% or more of a non-light emission duration and 2D images are displayed, as shown in FIG. 7, for example. Furthermore, (2) hardware is easily handled even in a display device receiving both signals of interlaced scan and signals of progressive scan, as shown in FIG. 12, for example.

Thus, although the embodiments of the display device and its driving method according to the present embodiment have been described, the present invention is not limited to the above embodiments. Those skilled in the art will be readily appreciated that various modifications and combinations of the structural elements and functions in the embodiments are possible without materially departing from the novel teachings and advantages of the present invention. Accordingly, all such modifications and combinations are intended to be included within the scope of this invention.

It should be noted in the present embodiment that the thin-film transistors (TFT) serving as the switches 62a to 62c and the driving transistor may be n-type or p-type, or combination of n-type and p-type. A channel layer of such a thin film transistor may include one of an amorphous silicon, a microcrystalline silicon, a polysilicon, an oxide semiconductor, and an organic semiconductor.

The EL element 64 is typically an organic luminescence element, but may be any current-light conversion device as long as it has luminescence intensity varying depending on a current.

Each of the structural elements in each of the above-described embodiments may be configured in the form of an exclusive hardware product, or may be realized by executing a software program suitable for the structural element. Each of the structural elements may be realized by means of a program executing unit, such as a CPU and a processor, reading and executing the software program recorded on a recording medium such as a hard disk or a semiconductor memory. Here, the software program for realizing the display device and its driving method according to each of the embodiments is a program described below.

The herein disclosed subject matter is to be considered descriptive and illustrative only, and the appended Claims are of a scope intended to cover and encompass not only the particular embodiment(s) disclosed, but also equivalent structures, methods, and/or uses.

### INDUSTRIAL APPLICABILITY

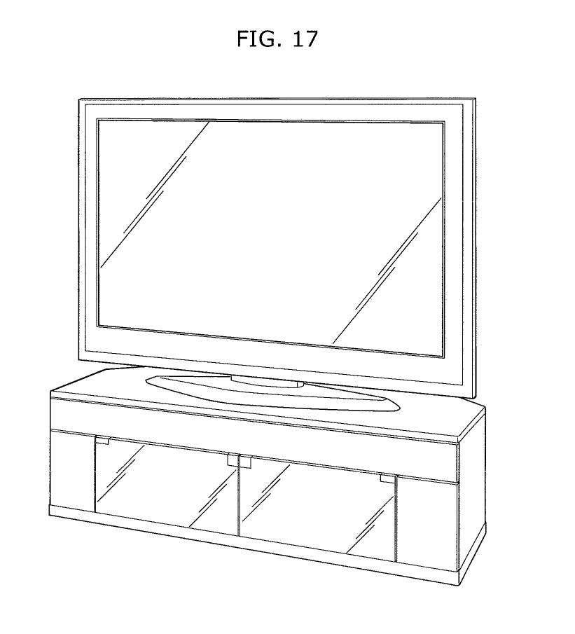

The display device and its driving method according to one or more exemplary embodiments disclosed herein are applicable especially to a FPD display device such as a television set as shown in FIG. 17.

1. A method of driving a display device including a plurality of luminescence pixels arranged in rows and columns,
each of the luminescence pixels having (a) a light-emission duration in which the each of the luminescence pixels emits light and (b) a non-light-emission duration in which the each of the luminescence pixels does not emit light, and
the method comprising:
(i) applying a black signal voltage to (a) a first target luminescence pixel in luminescence pixels in one row of each of the pairs of the rows and (b) a second target luminescence pixel in luminescence pixels in an other row of the each of the pairs at the same time, thereby starting the non-light-emission duration of the first target luminescence pixel and the non-light-emission duration of the second target luminescence pixel at the same time, and (ii) applying a first data signal voltage corresponding to the first target luminescence pixel to the first target luminescence pixel; and
(iii) applying a second data signal voltage corresponding to the second target luminescence pixel to the second target luminescence pixel, and (iv) causing the first target luminescence pixel and the second target luminescence pixel to emit light at the same time, based on the first data signal voltage and the second data signal voltage, respectively, thereby starting the light-emission duration of the first target luminescence pixel and the light-emission duration of the second target luminescence pixel at the same time,
wherein a set of (i) the applying of the black signal voltage to the first and second luminescence pixels, (ii) the applying of the first data signal voltage to the first target luminescence pixel, (iii) the applying of the second data signal voltage to the second target luminescence pixel, and (iv) the causing the first and second luminescence pixels to emit light starts at different times for the pairs of the rows.

2. The method according to claim 1,
wherein each of the luminescence pixels has a one-frame duration that consists of the light-emission duration and the non-light-emission duration, and
the method comprises:
(i) performing an operation of a light-emission duration in the one-frame duration for every one of the luminescence pixels arranged in rows and columns to display one of a right-eye image and a left-eye image of a three-dimensional image, and (ii) performing an operation of the light-emission duration in a next one-frame duration following the one-frame duration for every one of the luminescence pixels arranged in rows and columns to display an other one of the right-eye image and the left-eye image, thereby allowing a user to perceive the three-dimensional image through glasses that enable the user to sequentially see the right-eye image and the left-eye image.

3. The method according to claim 1,
wherein the luminescence pixels in the one row belong to one of an odd row group and an even row group of the rows, and
the luminescence pixels in the other row belong to an other of the odd row group and the even row group of the rows.

4. The method according to claim 1,
wherein the luminescence pixels in the one row belong to one of an upper region and a lower region of the rows, and
the luminescence pixels in the other row belong to an other of the upper region and the lower region of the rows.

5. A display device comprising:
a plurality of luminescence pixels arranged in rows and columns, each of the luminescence pixels having (a) a light-emission duration in which the each of the luminescence pixels emits light and (b) a non-light-emission duration in which the each of the luminescence pixels does not emit light;
a control unit configured to: (i) apply a black signal voltage to (a) a first target luminescence pixel in luminescence pixels in one row of each of the pairs of the rows and (b) a second target luminescence pixel in luminescence pixels in an other row of the each of the pairs at the same time, thereby starting the non-light-emission duration of the first target luminescence pixel and the non-light-emission duration of the second target luminescence pixel at the same time; (ii) apply a first data signal voltage corresponding to the first target luminescence pixel to the first target luminescence pixel; (iii) apply a second data signal voltage corresponding to the second target luminescence pixel to the second target luminescence pixel; and (iv) cause the first target luminescence pixel and the second target luminescence pixel to emit light at the same time, based on the first data signal voltage and the second data signal voltage, respectively, thereby starting the light-emission duration of the first target luminescence pixel and the light-emission duration of the second target luminescence pixel at the same time,
wherein the control unit is configured to perform a set of (i) the applying of the black signal voltage to the first and second luminescence pixels, (ii) the applying of the first data signal voltage to the first luminescence pixel, (iii) the applying of the second data signal voltage to the second luminescence pixel, and (iv) the causing the first and second luminescence pixels to emit light, the set starting at different times for the pairs of the rows.

6. The display device according to claim 5,
wherein each of the luminescence pixels includes at least:
a luminescence element;
a storage capacitor that stores a voltage;
a first switch that switches a state between a first power line that supplies the black signal voltage and a first electrode of the storage capacitor to be conductive or not to be conductive;
a second switch that switches a state between a signal line that supplies the data signal voltage and a second electrode of the storage capacitor to be conductive or not to be conductive;
a third switch that switches a state between the second electrode of the storage capacitor and a source electrode of a driving transistor to be conductive or not to be conductive; and
the driving transistor that causes a current corresponding to the data signal voltage to flow in the luminescence element, thereby causing the luminescence element to emit light, when a gate electrode of the driving transistor is conductive with the first electrode of the storage capacitor and the data signal voltage stored in the second electrode of the storage capacitor is conductive with the source electrode of the driving transistor,
wherein the switching by the first switch is synchronization with the switching by the second switch.
